(19) United States
(12) Patent Application Publication
(10) Pub. No.: US 2024/0336328 A1
(43) Pub. Date: Oct. 10, 2024

(54) BATTERY HOLDER AND BICYCLE COMPONENT

(71) Applicant: SHIMANO INC., Sakai City (JP)

(72) Inventors: Shota SUYAMA, Sakai City (JP); Atsuhiro EMURA, Sakai City (JP)

(73) Assignee: SHIMANO INC., Sakai City (JP)

(21) Appl. No.: 18/295,823

(22) Filed: Apr. 4, 2023

(51) Int. Cl. B62M 6/90; H01M 50/202; H01M 50/271

(52) U.S. Cl. CPC B62M 6/90; H01M 50/202; H01M 50/271

(57) ABSTRACT

A battery holder comprises a holder body and a holder lid. The holder body includes a holder space in which a battery is configured to be at least partially provided. The holder space includes an insertion opening through which the battery is configured to pass in a first direction. The holder body includes a side wall partially defining the holder space. The holder lid is attachable to the holder body to cover the insertion opening at least partially. The holder lid is configured to cover the side wall at least partially in an attachment state where the holder lid is attached to the holder body.

### BACKGROUND

### Technical Field

The present invention relates to a battery holder and a bicycle component.

### Background Information

A human-powered vehicle includes a device including a battery holder configured to hold a battery. One of objects of the present disclosure is to protect the battery holder from damage caused by physical contact between the battery holder and an obstacle.

### SUMMARY

In accordance with a first aspect of the present invention, a battery holder comprises a holder body and a holder lid. The holder body includes a holder space in which a battery is configured to be at least partially provided. The holder space includes an insertion opening through which the battery is configured to pass in a first direction. The holder body includes a side wall partially defining the holder space. The holder lid is attachable to the holder body to cover the insertion opening at least partially. The holder lid is configured to cover the side wall at least partially in an attachment state where the holder lid is attached to the holder body.

With the battery holder according to the first aspect, the holder lid at least partially protects the side wall from damage caused by physical contact between the side wall and an obstacle.

In accordance with a second aspect of the present invention, the battery holder according to the first aspect is configured so that the holder lid includes a battery receiving portion and a cover portion. The battery receiving portion is configured to receive the battery in a battery holding state where the battery is provided in the holder space and where the holder lid is attached to the holder body. The cover portion protrudes from the battery receiving portion to cover the side wall at least partially in the attachment state.

With the battery holder according to the second aspect, the cover portion at least partially protects the side wall from physical contact between the side wall and an obstacle.

In accordance with a third aspect of the present invention, the battery holder according to the second aspect is configured so that the side wall is configured to be at least partially provided between the battery and the cover portion in the battery holding state.

With the battery holder according to the third aspect, the cover portion reliably protects the side wall at least partially from physical contact between the side wall and an obstacle.

In accordance with a fourth aspect of the present invention, the battery holder according to the second or third aspect is configured so that the cover portion protrudes from the battery receiving portion in the first direction in the attachment state.

With the battery holder according to the fourth aspect, it is possible to arrange the cover portion to protect the side wall at least partially using the battery receiving portion.

In accordance with a fifth aspect of the present invention, the battery holder according to any one of the second to fourth aspects is configured so that the cover portion includes a cover end part. The cover portion extends from the battery receiving portion to the cover end part beyond the insertion opening in the first direction.

With the battery holder according to the fifth aspect, it is possible to reliably arrange the cover portion to protect the side wall at least partially using the battery receiving portion.

In accordance with a sixth aspect of the present invention, the battery holder according to the fifth aspect is configured so that the cover end part includes a first end part and a second end part. A first distance is defined between the first end part and the battery receiving portion in the first direction. A second distance is defined between the second end part and the battery receiving portion in the first direction. The first distance is different from the second distance.

With the battery holder according to the sixth aspect, it is possible to improve design flexibility of the cover portion.

In accordance with a seventh aspect of the present invention, the battery holder according to the sixth aspect is configured so that the second distance is defined as a maximum distance between the cover end part and the battery receiving portion in the first direction.

With the battery holder according to the seventh aspect, it is possible to expand a region in which the cover portion covers the side wall.

In accordance with an eighth aspect of the present invention, the battery holder according to the sixth or seventh aspect is configured so that the holder body is configured to be pivotally coupled to a base member about a first pivot axis. The holder body is configured to be pivotally coupled to a movable member about a second pivot axis. The first pivot axis is spaced apart from the second pivot axis in a fifth direction different from the first direction. The first end part is provided closer to the first pivot axis than the second end part in the fifth direction. The second end part is provided closer to the second pivot axis than the first end part in the fifth direction. The second distance is longer than the first distance.

With the battery holder according to the eighth aspect, it is possible to reliably protect a part of the side wall which is arranged close to the movable member.

In accordance with a ninth aspect of the present invention, the battery holder according to the eighth aspect is configured so that the cover end part includes an inclined end surface. The inclined end surface extends between the first end part and the second end part. The inclined end surface is non-perpendicular to and non-parallel to the first direction.

With the battery holder according to the ninth aspect, it is possible to save weight of the battery holder while protecting the side wall efficiently using the cover portion.

In accordance with a tenth aspect of the present invention, the battery holder according to any one of the second to seventh aspects is configured so that the holder body is configured to be pivotally coupled to a base member about a first pivot axis. The holder body is configured to be pivotally coupled to a movable member about a second pivot axis. The first pivot axis is spaced apart from the second pivot axis in a fifth direction different from the first direction. The cover portion is at least partially provided between the first pivot axis and the second pivot axis in the fifth direction as viewed in a sixth direction. The sixth direction is perpendicular to the first direction and the fifth direction.

With the battery holder according to the tenth aspect, it is possible to reliably protect a part of the side wall which is arranged between the first pivot axis and the second pivot axis in the fifth direction.

In accordance with an eleventh aspect of the present invention, the battery holder according to the tenth aspect further comprises a first pivot pin and a second pivot pin. The first pivot pin is configured to pivotally couple the holder body and the base member about the first pivot axis. The first pivot pin includes a first pin end and a first additional pin end and extending between the first pin end and the first additional pin end along the first pivot axis. The second pivot pin is configured to pivotally couple the holder body and the movable member about the second pivot axis. The second pivot pin includes a second pin end and a second additional pin end and extends between the second pin end and the second additional pin end along the second pivot axis. The holder lid is configured to cover at least one of the first pin end and the second pin end at least partially in the attachment state.

With the battery holder according to the eleventh aspect, the holder lid at least partially protects at least one of the first pin end and the second pin end while protecting the side wall at least partially.

In accordance with a twelfth aspect of the present invention, the battery holder according to the eleventh aspect is configured so that the holder body includes a first hole and a second hole. The first pin end is at least partially provided in the first hole. The second pin end is at least partially provided in the second hole. The holder lid is configured to cover at least one of the first hole and the second hole at least partially in the attachment state.

With the battery holder according to the twelfth aspect, the holder lid at least partially protects at least one of the first hole and the second hole while protecting the side wall and the at least one of the first pin end and the second pin end at least partially.

In accordance with a thirteenth aspect of the present invention, the battery holder according to any one of the second to twelfth aspects is configured so that the side wall includes a recess. The cover portion is configured to be at least partially provided in the recess in the attachment state.

With the battery holder according to the thirteenth aspect, the recess makes the battery holder comparatively compact while protecting the side wall at least partially.

In accordance with a fourteenth aspect of the present invention, the battery holder according to the thirteenth aspect is configured so that the side wall includes a wall portion and a protruding portion. The protruding portion protrudes from the wall portion away from the holder space. The wall portion and the protruding portion define the recess.

With the battery holder according to the fourteenth aspect, the recess makes the battery holder comparatively compact while protecting the wall portion at least partially.

In accordance with a fifteenth aspect of the present invention, the battery holder according to the fourteenth aspect is configured so that the cover portion includes an inclined end surface. The cover portion extends from the battery receiving portion to the inclined end surface in the first direction. The inclined end surface is non-perpendicular to and non-parallel to the first direction. The protruding portion includes an additional inclined end surface. The additional inclined end surface is non-perpendicular to and non-parallel to the first direction. The inclined end surface is configured to face the additional inclined end surface in the attachment state.

With the battery holder according to the fifteenth aspect, it is possible to save weight of the battery holder while protecting the side wall efficiently using the cover portion.

In accordance with a sixteenth aspect of the present invention, the battery holder according to any one of the second to fifteenth aspects is configured so that the holder space includes an end portion spaced apart from the insertion opening in the first direction. The holder space is at least partially provided between the end portion and the battery receiving portion in the first direction in the attachment state.

With the battery holder according to the sixteenth aspect, it is possible to effectively utilize a space defined between the end portion and the battery receiving portion in the first direction as a place where the battery is provided.

In accordance with a seventeenth aspect of the present invention, the battery holder according to the sixteenth aspect further comprises a biasing structure coupled to the battery receiving portion to bias the battery toward the end portion in the battery holding state.

With the battery holder according to the seventeenth aspect, the biasing structure makes the battery stable in the holder space in the battery holding state.

In accordance with an eighteenth aspect of the present invention, the battery holder according to the seventeenth aspect is configured so that the biasing structure is configured to be at least partially provided between the battery and the battery receiving portion in the battery holding state.

With the battery holder according to the eighteenth aspect, it is possible to effectively utilize a space provided between the battery and the battery receiving portion for a place where the biasing structure is provided.

In accordance with a nineteenth aspect of the present invention, the battery holder according to any one of the first to eighteenth aspects is configured so that the holder lid is at least partially provided farther from a mounting portion than the holder body in a mounting state where the battery holder is mounted to a vehicle body of a human-powered vehicle. The base member includes the mounting portion attached to the vehicle body in the mounting state.

With the battery holder according to the nineteenth aspect, the holder lid reliably protects the side wall from damage caused by physical contact between the side wall and an obstacle.

In accordance with a twentieth aspect of the present invention, a bicycle component comprises the battery holder according to any one of the first to nineteenth aspects.

With the bicycle component according to the twentieth aspect, it is possible to apply the battery holder to the bicycle component.

In accordance with a twenty-first aspect of the present invention, the bicycle component according to the twentieth aspect further comprises a base member, a movable member, and a linkage structure. The movable member is movable relative to the base member. The linkage structure movably couples the base member and the movable member. The battery holder is provided to the linkage structure.

With the bicycle component according to the twentieth-first aspect, it is possible to apply the structure of the battery holder to the bicycle component including the base member, the movable member, and the linkage structure.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a side elevational view of a bicycle including a derailleur in accordance with a first embodiment.

FIG. 2 is a side elevational view of the derailleur of the bicycle illustrated in FIG. 1.

FIG. 3 is a side elevational view of the derailleur illustrated in FIG. 2.

FIG. 4 is a rear view of the derailleur illustrated in FIG. 2.

FIG. 5 is a top view of the bicycle derailleur illustrated in FIG. 2.

FIG. 6 is a top view of a bicycle derailleur illustrated in accordance with a modification.

FIG. 7 is a perspective view of an internal structure of a motor unit of the bicycle derailleur illustrated in FIG. 2.

FIG. 8 is an exploded perspective view of a battery holder of the derailleur illustrated in FIG. 2.

FIG. 9 is an exploded perspective view of the battery holder of the derailleur illustrated in FIG. 2.

FIG. 10 is a cross-sectional view of the battery holder taken along line X-X of FIG. 15.

FIG. 11 is an exploded perspective view of the battery holder of the derailleur illustrated in FIG. 2.

FIG. 12 is a cross-sectional view of the battery holder taken along line XII-XII of FIG. 15.

FIG. 13 is an exploded perspective view of the battery holder of the derailleur illustrated in FIG. 2.

FIG. 14 is a cross-sectional view of the battery holder taken along line XIV-XIV of FIG. 15.

FIG. 15 is a cross-sectional view of the battery holder taken along line XV-XV of FIG. 14.

FIG. 16 is a cross-sectional view of the battery holder taken along line XVI-XVI of FIG. 15.

FIG. 17 is a cross-sectional view of the battery holder taken along line XVII-XVII of FIG. 19.

FIG. 18 is an exploded perspective view of a holder lid and a first biasing structure of the battery holder illustrated in FIG. 8.

FIG. 19 is a cross-sectional view of the battery holder taken along line XIX-XIX of FIG. 17.

FIG. 20 is a cross-sectional view of the battery holder taken along line XX-XX of FIG. 15.

FIG. 21 is a cross-sectional view of the battery holder taken along line XXI-XXI of FIG. 15.

FIG. 22 is a cross-sectional view of the battery holder taken along line XXII-XXII of FIG. 23.

FIG. 23 is a partial side elevational view of the derailleur illustrated in FIG. 2.

FIG. 24 is a side elevational view of the holder lid and the first biasing structure of the battery holder illustrated in FIG. 8.

FIG. 25 is a side elevational view of the battery holder illustrated in FIG. 8.

FIG. 26 is a cross-sectional view of the battery holder taken along line XXVI-XXVI of FIG. 25.

FIG. 27 is a cross-sectional view of the battery holder illustrated in FIG. 8.

FIG. 28 is a cross-sectional view of a battery holder in accordance with a modification.

### DESCRIPTION OF THE EMBODIMENTS

The embodiments will now be described with reference to the accompanying drawings, wherein like reference numerals designate corresponding or identical elements throughout the various drawings.

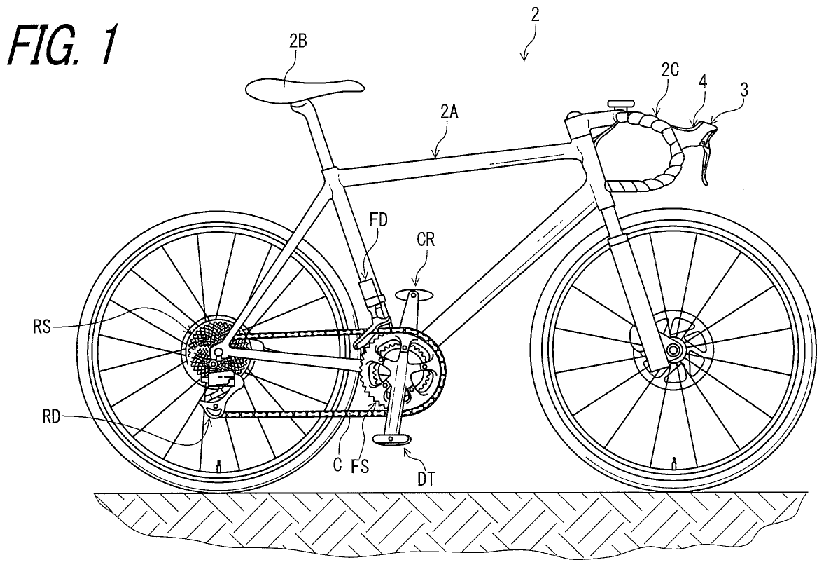

As seen in FIG. 1, a human-powered vehicle 2 includes a bicycle component RD in accordance with one of embodiments. The human-powered vehicle 2 further includes a vehicle body 2A, a saddle 2B, a handlebar 2C, an operating device 3, an operating device 4, and a drive train DT. The operating devices 3 and 4 are configured to be mounted to the handlebar 2C. The drive train DT includes a crank CR, a front sprocket assembly FS, a rear sprocket assembly RS, a chain C, a bicycle component FD, and the bicycle component RD. The front sprocket assembly FS is secured to the crank CR. The rear sprocket assembly RS is rotatably mounted to the vehicle body 2A. The chain C is engaged with the front sprocket assembly FS and the rear sprocket assembly RS. The bicycle component RD is mounted to the vehicle body 2A and is configured to shift the chain C relative to a plurality of sprockets of the rear sprocket assembly RS to change a gear position. The bicycle component FD is configured to shift the chain C relative to a plurality of sprockets of the front sprocket assembly FS.

In the present application, the term “human-powered vehicle” includes a vehicle to travel with a motive power including at least a human power of a user (i.e., rider) who rides the vehicle. The human-powered vehicle includes a various kind of bicycles such as a mountain bike, a road bike, a city bike, a cargo bike, a hand bike, and a recumbent bike. Furthermore, the human-powered vehicle includes an electric bike (E-bike). The electric bike includes an electrically assisted bicycle configured to assist propulsion of a vehicle with an electric motor. However, a total number of wheels of the human-powered vehicle is not limited to two. For example, the human-powered vehicle includes a vehicle having one wheel or three or more wheels. Especially, the human-powered vehicle does not include a vehicle that uses only a driving source (e.g., an internal-combustion engine, an electric motor) as motive power. Generally, a light road vehicle, which includes a vehicle that does not require a driver's license for a public road, is assumed as the human-powered vehicle.

In the illustrated embodiment, the bicycle component RD is applied to a road bike. However, the bicycle component RD can be applied to an any kind of human-powered vehicles such as a mountain bike, a road bike, a city bike, a cargo bike, a hand bike, and a recumbent bike if needed and/or desired. Furthermore, the bicycle component RD or modifications thereof can be applied to an electric bike (E-bike). The electric bike includes an electrically assisted bicycle configured to assist propulsion of a vehicle with an electric motor.

The bicycle component RD is configured to be operated using the operating device 3. The bicycle component FD is configured to be operated using the operating device 4. The bicycle component RD is configured to be electrically connected to the operating devices 3 and 4. The bicycle component RD is configured to be electrically connected to the bicycle component FD.

In the first embodiment, the bicycle component RD is configured to be wirelessly connected to the operating devices 3 and 4. The bicycle component RD is configured to be wirelessly connected to the bicycle component FD. The bicycle component RD can be configured to be wirelessly communicate with the bicycle component FD via at least one of a cycle computer, smart phone, a tablet, and a personal computer. The bicycle component RD is configured to change the gear position in response to a control signal transmitted from the operating device 3. The bicycle component RD is configured to transmit, to the bicycle component FD, a control signal transmitted from the operating device 4. The bicycle component FD is configured to change the gear position in response to the control signal transmitted from the operating device 4 via the bicycle component RD. Each of the derailleurs RD and FD includes an electric power source such as a battery. However, at least one of the derailleurs RD and FD can be electrically connected to another electric power source such as a battery via an electric cable if needed and/or desired. Both the bicycle component RD and the bicycle component FD can be electrically connected to another electric power source such as a battery via an electric cable if needed and/or desired.

In the first embodiment, the bicycle component RD includes a rear derailleur, and the bicycle component FD includes a front derailleur. Namely, the bicycle component RD can also be referred to as a bicycle rear bicycle component RD. The bicycle component FD can also be referred to as a bicycle front bicycle component FD. Structures of the bicycle component RD can be applied to other bicycle components such as the bicycle component FD if needed and/or desired.

In the present application, the following directional terms “front,” “rear,” “forward,” “rearward,” “left,” “right,” “transverse,” “upward” and “downward” as well as any other similar directional terms refer to those directions which are determined on the basis of a user (e.g., a rider) who is in the user's standard position (e.g., on the saddle 2B or a seat) in the human-powered vehicle 2 with facing the handlebar 2C. Accordingly, these terms, as utilized to describe the bicycle component RD or other components, should be interpreted relative to the human-powered vehicle 2 equipped with the bicycle component RD as used in an upright riding position on a horizontal surface.

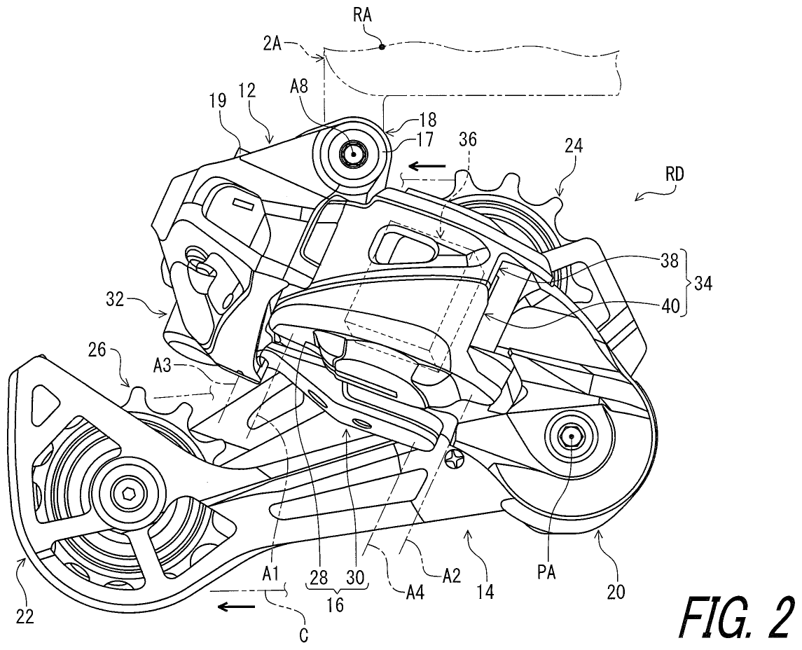

As seen in FIG. 2, the bicycle component RD comprises a base member 12, a movable member 14, and a linkage structure 16. The base member 12 is configured to be coupled to the vehicle body 2A. The base member 12 is configured to be coupled to the vehicle body 2A with a derailleur fastener 17. The movable member 14 is movable relative to the base member 12. The linkage structure 16 movably couples the base member 12 and the movable member 14.

The base member 12 includes a mounting portion 18. The mounting portion 18 is configured to be fastened to the vehicle body 2A with the derailleur fastener 17. The derailleur fastener 17 has a fastener center axis A8.

The base member 12 is pivotally coupled to the vehicle body 2A about the derailleur fastener 17. The bicycle component RD includes an adjustment member 19. The adjustment member 19 is configured to change an orientation of the base member 12 relative to the vehicle body 2A about the derailleur fastener 17 in a state where the derailleur fastener 17 is loosened. Examples of the adjustment member 19 include a screw. The derailleur fastener 17 is tightened to secure the base member 12 to the vehicle body 2A in a state where the base member 12 is in a position adjusted using the adjustment member 19.

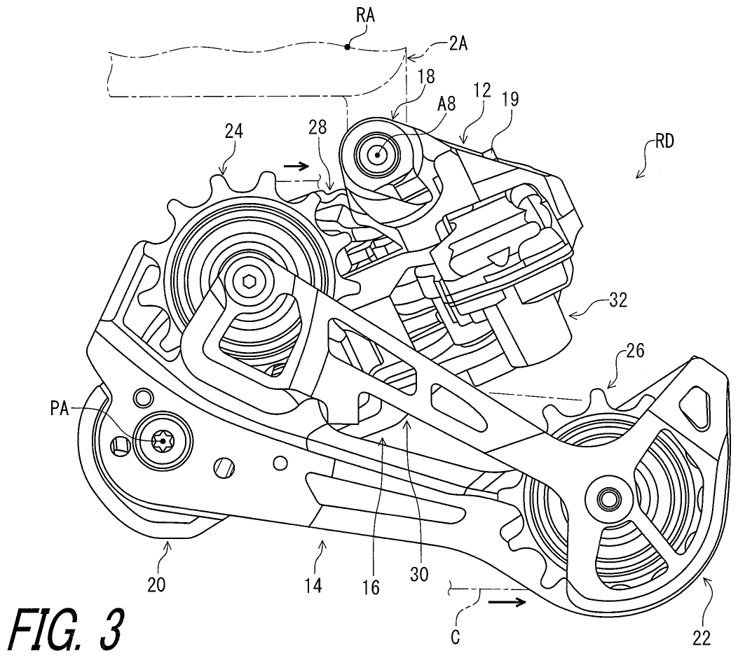

As seen in FIG. 3, the movable member 14 includes a coupling member 20, a guide plate 22, a guide pulley 24, and a tension pulley 26. The guide plate 22 is pivotally coupled to the coupling member 20 about the pivot axis PA. The guide pulley 24 is rotatably coupled to the guide plate 22. The tension pulley 26 is rotatably coupled to the guide plate 22. The guide pulley 24 is configured to be engaged with the chain C. The tension pulley 26 is configured to be engaged with the chain C. The structure of the movable member 14 is not limited to the above structure. For example, the coupling member 20 can be omitted from the movable member 14 if needed and/or desired. The movable member 14 can also be referred to as a movable member 14.

As seen in FIG. 2, the linkage structure 16 movably couples the base member 12 and the movable member 14. The linkage structure 16 movably couples the base member 12 and the coupling member 20. In the present embodiment, the linkage structure 16 includes a first link 28 and a second link 30. The first link 28 is pivotally coupled to the base member 12 about a first pivot axis A1. The first link 28 is pivotally coupled to the movable member 14 (e.g., the coupling member 20) about a second pivot axis A2. The second link 30 is pivotally coupled to the base member 12 about a third pivot axis A3. The second link 30 is pivotally coupled to the movable member 14 (e.g., the coupling member 20) about a fourth pivot axis A4. The first to fourth pivot axes A1 to A4 are parallel to each other. However, one of the first link 28 and the second link 30 can be omitted from the linkage structure 16 if needed and/or desired. The structure of the linkage structure 16 is not limited to the above structure. At least one of the first to fourth pivot axes A1 to A4 can be non-parallel to another of the first to fourth pivot axes A1 to A4.

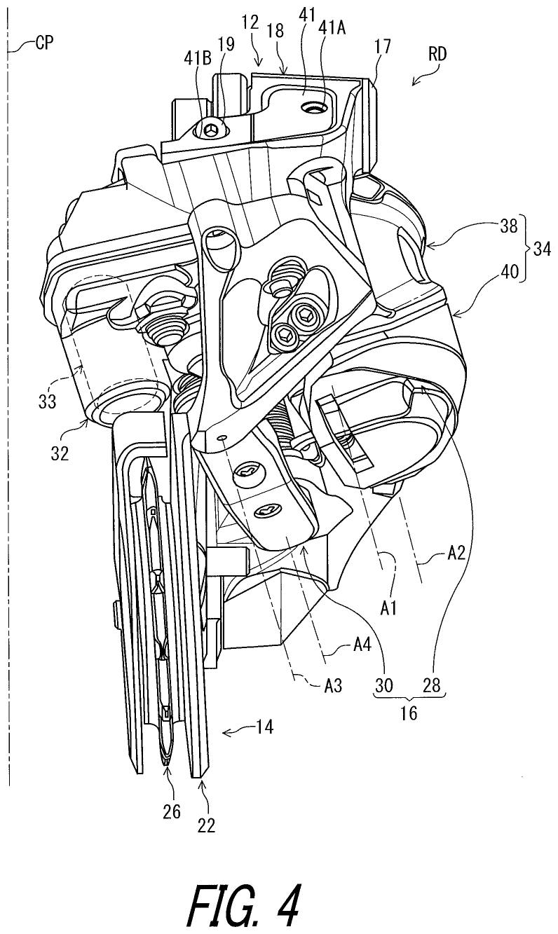

As seen in FIG. 4, the second link 30 is at least partially provided between the first link 28 and a transverse center plane CP of the human-powered vehicle 2. The transverse center plane CP is defined to be perpendicular to a sprocket rotational axis RA (see e.g., FIG. 2) of the rear sprocket assembly RS (see e.g., FIG. 1).

The bicycle component RD comprises a motor unit 32. The motor unit 32 comprises an electrical actuator 33. Examples of the electrical actuator 33 include an electric motor. The electrical actuator 33 is configured to generate a driving force. The driving force includes a driving rotational force. In the present application, the term “rotational force” can also be referred to as “torque” or “moment.” The electrical actuator 33 is configured to generate the driving rotational force. The electrical actuator 33 is configured to generate the driving rotational force to actuate an actuated device of the human-powered vehicle 2. In the present embodiment, the electrical actuator 33 is configured to generate the driving rotational force to move the movable member 14 relative to the base member 12. However, the electrical actuator 33 can be configured to actuate another device other than the bicycle component RD if needed and/or desired.

The motor unit 32 is provided to one of the base member 12, the movable member 14, and the linkage structure 16. The electrical actuator 33 is provided to one of the base member 12, the movable member 14, and the linkage structure 16. In the present embodiment, the motor unit 32 is provided to the base member 12. The electrical actuator 33 is provided to the base member 12. However, the motor unit 32 can be provided to one of the movable member 14 and the linkage structure 16 if needed and/or desired. The electrical actuator 33 can be provided to one of the movable member 14 and the linkage structure 16 if needed and/or desired.

The motor unit 32 is provided to the base member 12 to apply the driving force (e.g., the driving rotational force) to the movable member 14. The motor unit 32 is configured to move at least one of the movable member 14 and the linkage structure 16 relative to the base member 12. In the present embodiment, the motor unit 32 is coupled to the linkage structure 16 to move the movable member 14 via the linkage structure 16. However, the motor unit 32 can be directly coupled to the movable member 14 to move the movable member 14 relative to the base member 12 if needed and/or desired.

The motor unit 32 includes at least one gear. The at least one gear is configured to transmit the driving rotational force to the linkage structure 16. For example, the at least one gear is configured to transmit the driving rotational force to the second link 30. However, the at least one gear is configured to transmit the driving rotational force to the first link 28 or the movable member 14 if needed and/or desired. The motor unit 32 can include other structures such as a protection structure (e.g., a torque limiter) if needed and/or desired.

As seen in FIG. 2, the bicycle component RD comprises a battery holder 34. The battery holder 34 is configured to detachably hold a battery 36. The battery holder 34 is electrically connected to the motor unit 32 to supply electricity from the battery 36 to the motor unit 32. Examples of the battery 36 include a primary battery and a secondary battery. However, the battery holder 34 can be omitted from the bicycle component RD if needed and/or desired. In such embodiments, the bicycle component RD can be configured to be electrically connected to another electric power source if needed and/or desired.

The battery holder 34 comprises a holder body 38 and a holder lid 40. The holder body 38 is pivotally coupled to the base member 12 about the first pivot axis A1. The holder body 38 is pivotally coupled to the movable member 14 about the second pivot axis A2. The holder lid 40 is attachable to the holder body 38. The holder lid 40 is detachably attached to the holder body 38.

As seen in FIG. 2, the battery holder 34 is provided to one of the base member 12, the movable member 14, and the linkage structure 16. The motor unit 32 is provided to one of the base member 12, the movable member 14, and the linkage structure 16. The battery holder 34 is provided to another of the base member 12, the movable member 14, and the linkage structure 16. The motor unit 32 is provided to one of the base member 12 and the linkage structure 16. The battery holder 34 is provided to the other of the base member 12 and the linkage structure 16.

In the present embodiment, the motor unit 32 is provided to the base member 12. The battery holder 34 is provided to the linkage structure 16. The battery holder 34 is provided to the first link 28. The holder body 38 is configured to be pivotally coupled to the base member 12 about the first pivot axis A1. The holder body 38 is configured to be pivotally coupled to the movable member 14 about the second pivot axis A2.

However, the motor unit 32 can be provided to one of the movable member 14 and the linkage structure 16 if needed and/or desired. The motor unit 32 can be provided to one of the first link 28 and the second link 30 if needed and/or desired. The battery holder 34 can be provided to one of the base member 12 and the movable member 14 if needed and/or desired. The battery holder 34 can be provided to the second link 30 if needed and/or desired. The battery holder 34 can be omitted from the motor unit 32 if needed and/or desired.

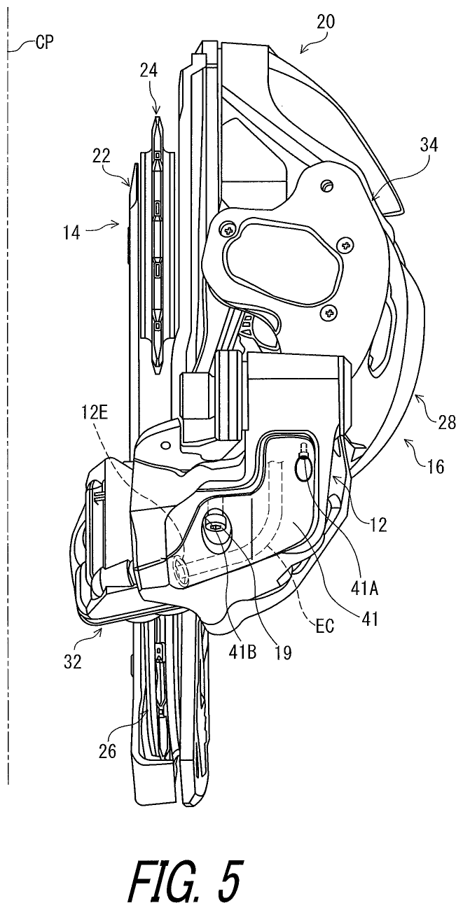

As seen in FIG. 5, the bicycle component RD includes a cover 41. The cover 41 is attached to the base member 12. The cover 41 is secured to the base member 12 with a fastener 41A such as a screw. The adjustment member 19 is provided at least partially outside the cover 41 in a cover attachment state where the cover 41 is attached to the base member 12. The cover 41 includes a hole 41B. The adjustment member 19 extends through the hole 41B of the cover 41 in the cover attachment state.

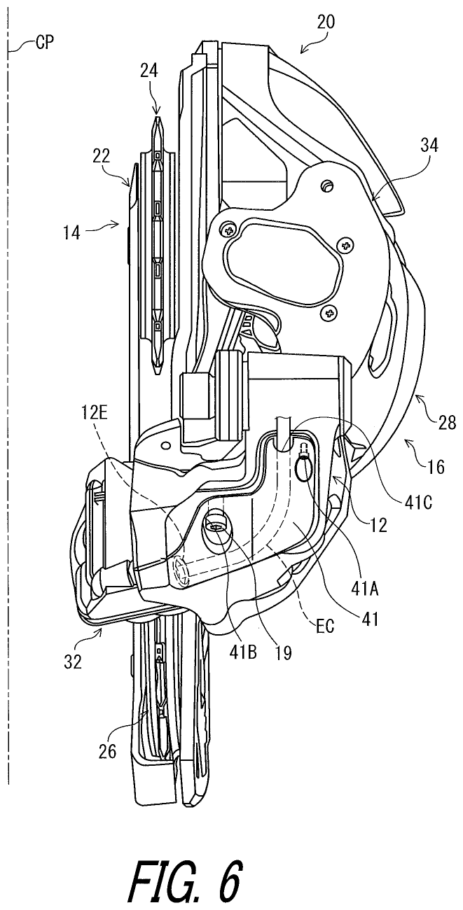

The base member 12 includes a connection port 12E to which an electric cable EC is electrically connected. The cover 41 at least partially covers the connection port 12E in the cover attachment state. The cover 41 at least partially covers the electric cable EC in the cover attachment state. The motor unit 32 is configured to be powered by electricity supplied from the battery 36 or electricity supplied from an external power source via the electric cable EC. The cover 41 can be omitted from the bicycle component RD if needed and/or desired. As seen in FIG. 6, the cover 41 can include an opening 41C through which the electric cable EC extends if needed and/or desired. In the modification depicted in FIG. 6, the electric cable EC extends from the connection port 12E to an outside of the cover 41 through the opening 41C. In FIG. 6, for example, electricity is supplied via the connection port 12E from an external electric power source (e.g., an electric power source of an assist drive unit, an electric power source provided independently from bicycle components).

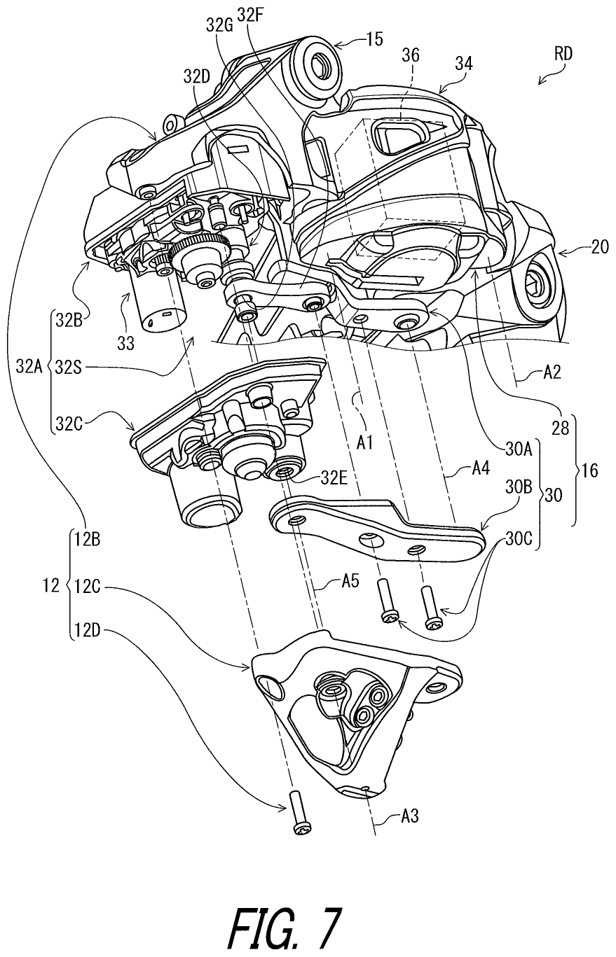

As seen in FIG. 7, the motor unit 32 further comprises a housing 32A including an internal space 32S. In the present embodiment, the housing 32A is a separate member from the base member 12. However, the housing 32A can be at least partially provided integrally with the base member 12 as a one-piece unitary member.

The base member 12 includes a first base body 12B, a second base body 12C, and a fastener 12D. The first base body 12B is configured to be coupled to the vehicle body 2A (see e.g., FIG. 2) with the derailleur fastener 17. The second base body 12C is a separate member from the first base body 12B. The second base body 12C is fastened to the first base body 12B with the fastener 12D such as a screw. The motor unit 32 is provided between the first base body 12B and the second base body 12C. The housing 32A is held between the first base body 12B and the second base body 12C.

As seen in FIG. 7, the housing 32A includes a first housing 32B and a second housing 32C. The first housing 32B and the second housing 32C define the internal space 32S between the first housing 32B and the second housing 32C. In the present embodiment, the second housing 32C is a separate member from the first housing 32B. However, the second housing 32C can be integrally provided with the first housing 32B as a one-piece unitary member if needed and/or desired.

The electrical actuator 33 is configured to generate the driving rotational force using electricity supplied from the battery 36 via the battery holder 34. The electrical actuator 33 is electrically connected to the battery holder 34. The electrical actuator 33 is provided in the internal space 32S of the housing 32A. The electrical actuator 33 is provided between the first housing 32B and the second housing 32C.

The motor unit 32 comprises an output member 32D. The electrical actuator 33 is coupled to the output member 32D to rotate the output member 32D relative to the housing 32A about an output rotational axis A5. The output member 32D extends along the output rotational axis A5. In the present embodiment, the output rotational axis A5 is coincident with the third pivot axis A3. The output member 32D is rotatable relative to the housing 32A about the third pivot axis A3. The second link 30 is rotatable relative to the base member 12 about the output rotational axis A5. However, the output rotational axis A5 can be offset from the third pivot axis A3 if needed and/or desired.

The second link 30 is coupled to the output member 32D to receive, from the output member 32D, the driving rotational force transmitted from the electrical actuator 33 to the output member 32D. The second link 30 is coupled to the output member 32D to rotate along with the output member 32D relative to the housing 32A and the base member 12 about the third pivot axis A3. The second link 30 includes an inner link body 30A, an inner link lever 30B, and fasteners 30C. The inner link body 30A is pivotally coupled to the base member 12 about the third pivot axis A3. The inner link body 30A is pivotally coupled to the movable member 14 about the fourth pivot axis A4. The inner link lever 30B is fastened to the inner link body 30A with the fasteners 30C. The inner link lever 30B is coupled to the output member 32D to receive, from the output member 32D, the driving rotational force transmitted from the electrical actuator 33. The inner link lever 30B is coupled to the output member 32D to rotate along with the output member 32D relative to the housing 32A and the base member 12 about the third pivot axis A3.

The output member 32D is provided partially outside the housing 32A. The output member 32D protrudes from the housing 32A. For example, the housing 32A includes a hole 32E. The second housing 32C includes the hole 32E. The output member 32D extends through the hole 32E.

The motor unit 32 includes an arm 32F. The arm 32F is coupled to the output member 32D and is provided outside the housing 32A. The arm 32F is provided between the housing 32A and the inner link lever 30B. The arm 32F couples the output member 32D and the second link 30 to transmit an output rotational force from the output member 32D to the second link 30. The arm 32F includes a coupling hole 32G. The output member 32D extends through the coupling hole 32G. For example, the output member 32D is press-fitted in the coupling hole 32G. The arm 32F is coupled to the inner link body 30A.

The arm 32F is secured to the inner link body 30A with the fastener 30C. The arm 32F is at least partially provided between the inner link body 30A and the inner link lever 30B. The arm 32F and the inner link lever 30B are secured to the inner link body 30A with the fastener 30C. Since the arm 32F is secured to the inner link body 30A with the fastener 30C, it is possible to restrict the arm 32F from falling off the inner link body 30A and to restrict the arm 32F from rotating relative to the inner link body 30A.

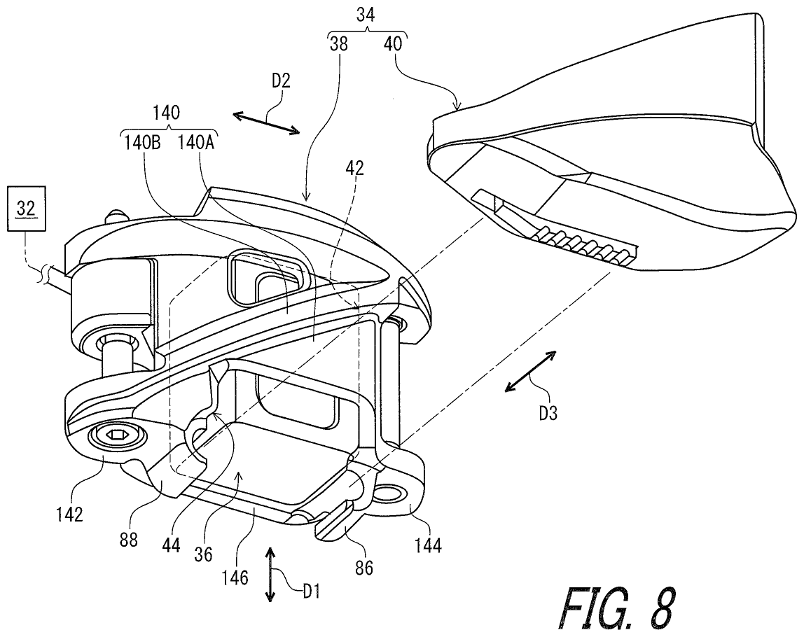

As seen in FIG. 8, the holder body 38 includes a holder space 42 in which the battery 36 is configured to be at least partially provided. In the present embodiment, the battery 36 is configured to be partially provided in the holder space 42. However, the battery 36 can be configured to be entirely provided in the holder space 42 if needed and/or desired.

The holder body 38 is configured to restrict the battery 36 from moving relative to the holder body 38 in a second direction D2 and a third direction D3 in a state where the battery 36 is in the holder space 42. The second direction D2 intersects with the first direction D1. The third direction D3 intersects with the first direction D1. The third direction D3 intersects with the second direction D2. In the present embodiment, the second direction D2 is perpendicular to the first direction D1. The second direction D2 is perpendicular to the first direction D1. The third direction D3 is perpendicular to the first direction D1. The third direction D3 is perpendicular to the second direction D2. However, the second direction D2 can be non-perpendicular to the first direction D1 if needed and/or desired. The third direction D3 can be non-perpendicular to at least one of the first direction D1 and the second direction D2 if needed and/or desired.

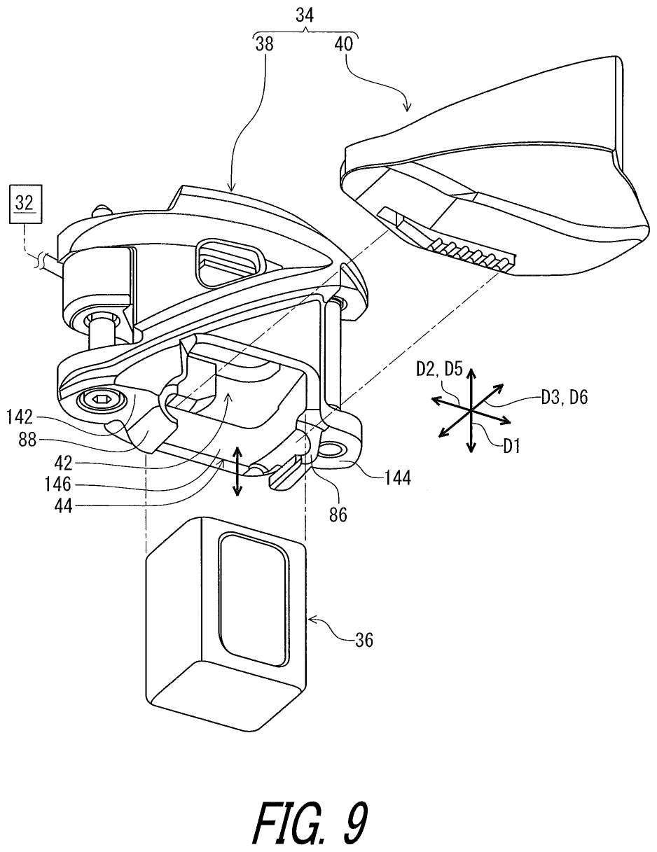

As seen in FIG. 9, the holder space 42 includes an insertion opening 44 through which the battery 36 is configured to pass in a first direction D1. The battery 36 is inserted into or ejected from the holder space 42 through the insertion opening 44 in a state where the holder lid 40 is detached from the holder body 38.

The holder lid 40 is attachable to the holder body 38 in the third direction D3. The holder lid 40 is detachable from the holder body 38 in the third direction D3. However, the holder lid 40 can be configured to be attachable to the holder body 38 in a direction other than the third direction D3 if needed and/or desired. The holder lid 40 can be configured to be detachable from the holder body 38 in a direction other than the third direction D3 if needed and/or desired.

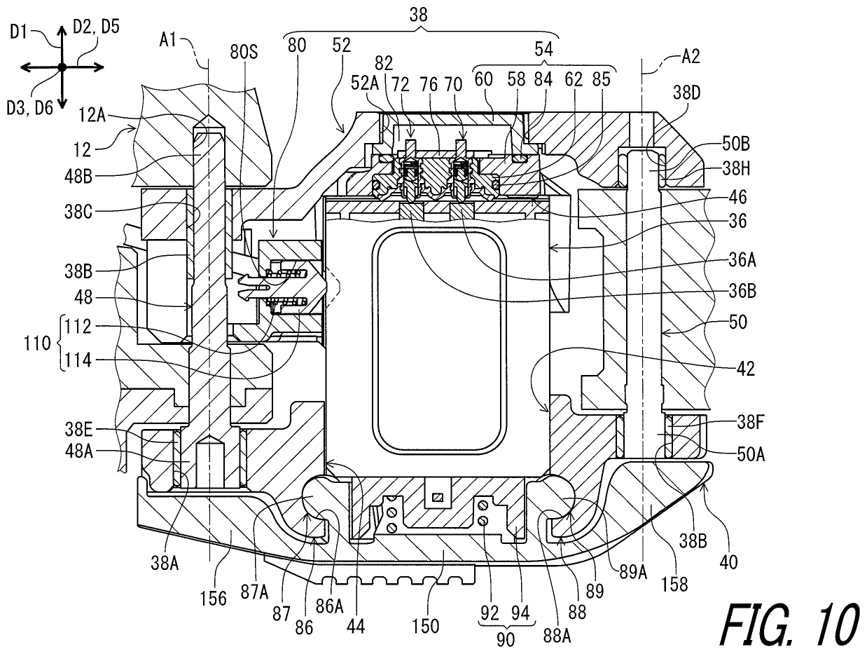

As seen in FIG. 10, the holder lid 40 is attachable to the holder body 38 to cover the insertion opening 44 at least partially. In the present embodiment, the holder lid 40 is attachable to the holder body 38 to cover the insertion opening 44 entirely. However, the holder lid 40 can be configured to be attachable to the holder body 38 to cover the insertion opening 44 partially if needed and/or desired.

The holder space 42 includes an end portion 46. The end portion 46 is spaced apart from the insertion opening 44 in the first direction D1. The holder space 42 is provided between the insertion opening 44 and the end portion 46. The battery 36 is inserted toward the end portion 46 through the insertion opening 44 in the first direction D1.

As seen in FIG. 10, the battery holder 34 further comprises a first pivot pin 48 and a second pivot pin 50. The first pivot pin 48 is configured to pivotally couple the holder body 38 and the base member 12 about the first pivot axis A1. The first pivot pin 48 includes a first pin end 48A and a first additional pin end 48B and extends between the first pin end 48A and the first additional pin end 48B along the first pivot axis A1.

The second pivot pin 50 is configured to pivotally couple the holder body 38 and the movable member 14 about the second pivot axis A2. The second pivot pin 50 includes a second pin end 50A and a second additional pin end 50B and extends between the second pin end 50A and the second additional pin end 50B along the second pivot axis A2.

The holder body 38 includes a first hole 38A and a second hole 38B. The first pin end 48A is at least partially provided in the first hole 38A. The second pin end 50A is at least partially provided in the second hole 38B. In the present embodiment, the first pin end 48A is entirely provided in the first hole 38A. The second pin end 50A is entirely provided in the second hole 38B. However, the first pin end 48A can be partially provided in the first hole 38A if needed and/or desired. The second pin end 50A can be partially provided in the second hole 38B if needed and/or desired.

The holder body 38 includes a third hole 38C and a fourth hole 38D. The first pivot pin 48 extends through the third hole 38C. The base member 12 includes a support hole 12A. The first additional pin end 48B is at least partially provided in the support hole 12A. The second additional pin end 50B is at least partially provided in the fourth hole 38D. In the present embodiment, the first additional pin end 48B is entirely provided in the support hole 12A. The second additional pin end 50B is entirely provided in the fourth hole 38D. However, the first additional pin end 48B can be partially provided in the support hole 12A if needed and/or desired. The second additional pin end 50B can be partially provided in the fourth hole 38D if needed and/or desired.

The holder body 38 includes bearings 38E, 38F, 38G, and 38H. The bearing 38E is provided in the first hole 38A to rotatably support the first pin end 48A about the first pivot axis A1. The bearing 38F is provided in the second hole 38B to rotatably support the second pin end 50A about the second pivot axis A2. The bearing 38G is provided in the third hole 38C to rotatably support the first additional pin end 48B about the first pivot axis A1. The bearing 38H is provided in the fourth hole 38D to rotatably support the second additional pin end 50B about the second pivot axis A2.

The first pivot axis A1 extends in the first direction D1. The second pivot axis A2 extends in the first direction D1. The first pivot axis A1 is parallel to the first direction D1. The second pivot axis A2 is parallel to the first direction D1. The second pivot axis A2 is parallel to the first pivot axis A1. However, each of the first pivot axis A1 and the second pivot axis A2 can be non-parallel to the first direction D1 if needed and/or desired. The second pivot axis A2 can be non-parallel to the first pivot axis A1 if needed and/or desired.

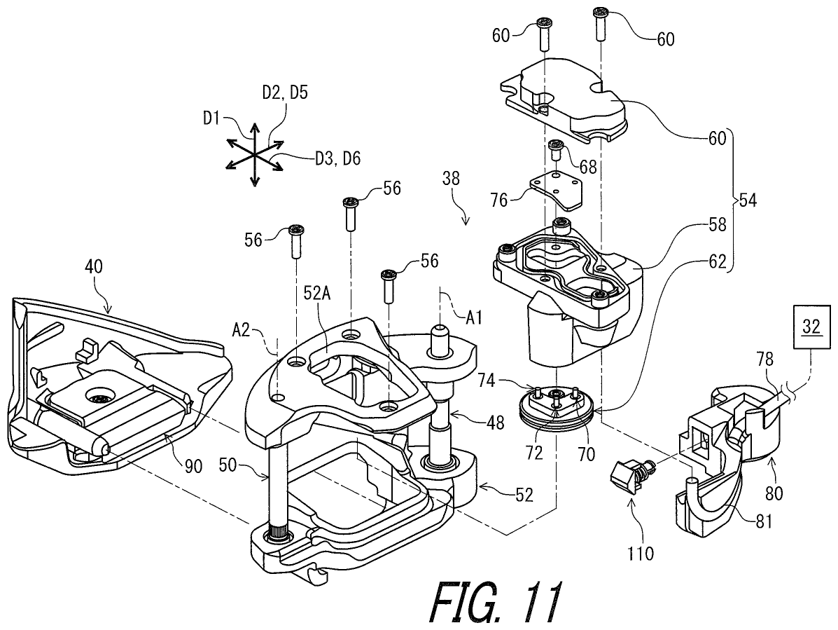

As seen in FIG. 11, the holder body 38 includes a main body 52 and a connector unit 54. The main body 52 is pivotally coupled to the base member 12 (see e.g., FIG. 10) about the first pivot axis A1. The main body 52 is pivotally coupled to the movable member 14 (see e.g., FIG. 10) about the second pivot axis A2.

The connector unit 54 is coupled to the main body 52 with fasteners 56. The main body 52 includes an attachment opening 52A. The connector unit 54 is at least partially provided in the attachment opening 52A. In the present embodiment, the connector unit 54 is a separate member from the main body 52. However, the connector unit 54 can be at least partially provided integrally with the main body 52 as a one-piece unitary member if needed and/or desired.

The connector unit 54 includes a connector base 58, a cover 60, and a terminal unit 62. The connector base 58 is coupled to the main body 52 with the fasteners 56. The cover 60 is coupled to the connector base 58 with fasteners 66. The terminal unit 62 is coupled to the connector base 58 with a fastener 68.

The battery holder 34 further comprises an electrical contact 70. The electrical contact 70 is coupled to the holder body 38. The battery holder 34 further comprises an electrical contact 72. The electrical contact 72 is coupled to the holder body 38. The battery holder 34 further comprises an electrical contact 74. The electrical contact 74 is coupled to the holder body 38. The electrical contacts 70, 72, and 74 are coupled to the terminal unit 62.

In the present embodiment, the electrical contacts 70, 72, and 74 have the same structures. The electrical contact 70 includes a positive contact, and the electrical contact 72 includes a negative contact. The electrical contact 74 is not used as a contact. Each of the electrical contacts 70, 72, and 74 can include other structures if needed and/or desired. The electrical contact 74 can be omitted from the battery holder 34 if needed and/or desired.

The battery holder 34 further comprises a circuit board 76. The circuit board 76 is coupled to the holder body 38. The circuit board 76 is coupled to the connector base 58 with the fastener 68. The electrical contacts 70, 72, and 74 are electrically connected to the circuit board 76. For example, the electrical contacts 70, 72, and 74 are electrically connected to an electrical conductor of the circuit board 76 via soldering.

The battery holder 34 further comprises an electrical cable 78. The electrical cable 78 is configured to electrically connect the electrical contact 70 and/or 72 and the electrical actuator 33.

The holder body 38 includes a cable holder 80. The cable holder 80 is configured to hold the electrical cable 78. The cable holder 80 is coupled to the main body 52. The cable holder 80 includes a cable groove 81 in which the electrical cable 78 is at least partially provided in a cable holding state where the cable holder 80 holds the electrical cable 78. In the present embodiment, the cable holder 80 is a separate member from the main body 52 and the connector unit 54. However, the cable holder 80 can be at least partially provided integrally with at least one of the main body 52 and the connector unit 54 as a one-piece unitary member if needed and/or desired.

As seen in FIG. 10, the main body 52, the connector unit 54, and the cable holder 80 define the holder space 42. The holder space 42 is in communicate with an outside space of the battery holder 34. The holder body 38 is configured to cover the battery 36 partially in a battery holding state where the battery 36 is provided in the holder space 42 and where the holder lid 40 is attached to the holder body 38. However, the holder space 42 can be configured not to be in communicate with the outside space of the battery holder 34 if needed and/or desired. The holder body 38 can be configured to cover the battery 36 entirely in the battery holding state if needed and/or desired.

The main body 52 includes the first hole 38A, the second hole 38B, the third hole 38C, and the fourth hole 38D. The main body 52 is integrally provided as a one-piece unitary member. However, the main body 52 can include at least two separate members if needed and/or desired.

A space 82 is defined by the connector base 58, the cover 60, and the terminal unit 62. The connector unit 54 includes seal members 84 and 85. The seal member 84 is provided between the connector base 58 and the cover 60. The seal member 85 is provided between the connector base 58 and the terminal unit 62. The space 82 is sealed by the seal members 84 and 85. The circuit board 76 is provided in the space 82.

The electrical contact 70 is provided to the end portion 46. The electrical contact 72 is provided to the end portion 46. The electrical contact 70 is contactable with a battery terminal 36A of the battery 36. The electrical contact 72 is contactable with a battery terminal 36B of the battery 36.

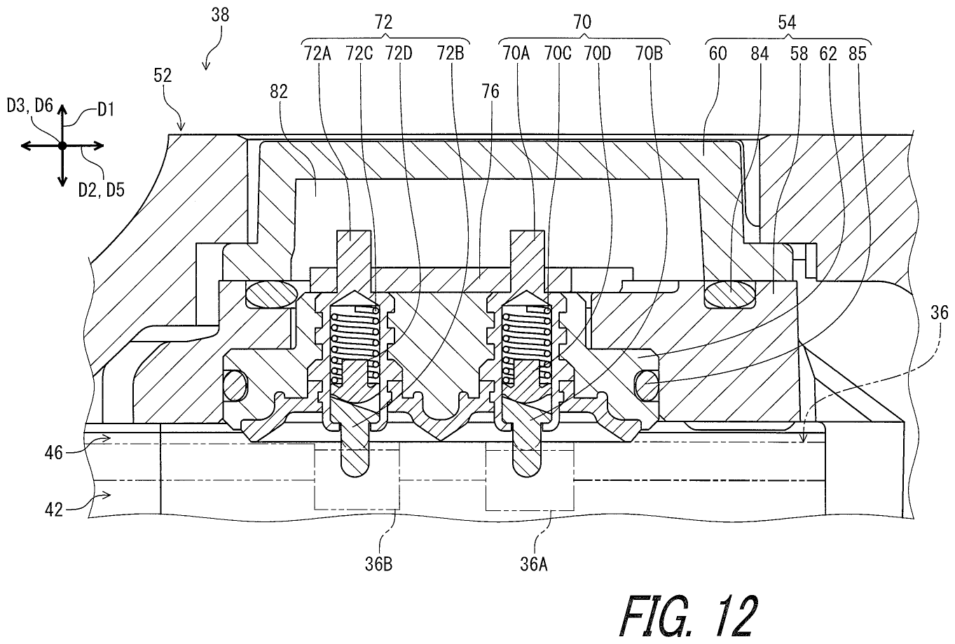

As seen in FIG. 12, the electrical contact 70 is configured to change a length of the electrical contact 70. The electrical contact 70 includes a first contact member 70A, a second contact member 70B, a biasing member 70C, and a receiving member 70D. The second contact member 70B is in slidable contact with the first contact member 70A. The second contact member 70B is movable relative to the first contact member 70A to maintain contact between the first contact member 70A and the second contact member 70B.

The second contact member 70B, the biasing member 70C, and the receiving member 70D are movably provided in the first contact member 70A. The receiving member 70D is provided between the second contact member 70B and the biasing member 70C. The biasing member 70C is configured to bias the first contact member 70A and the second contact member 70B to increase the length of the electrical contact 70. The biasing member 70C is configured to bias the first contact member 70A and the second contact member 70B to maintain contact between the second contact member 70B and the battery terminal 36A.

The electrical contact 72 is configured to change a length of the electrical contact 72. The electrical contact 72 includes a first contact member 72A, a second contact member 72B, a biasing member 72C, and a receiving member 72D. The second contact member 72B is in slidable contact with the first contact member 72A. The second contact member 72B is movable relative to the first contact member 72A to maintain contact between the first contact member 72A and the second contact member 72B.

The second contact member 72B, the biasing member 72C, and the receiving member 72D are movably provided in the first contact member 72A. The receiving member 72D is provided between the second contact member 72B and the biasing member 72C. The biasing member 72C is configured to bias the first contact member 72A and the second contact member 72B to increase the length of the electrical contact 72. The biasing member 72C is configured to bias the first contact member 72A and the second contact member 72B to maintain contact between the second contact member 72B and the battery terminal 36B.

As seen in FIG. 10, the holder body 38 includes a first coupling part 86. The holder lid 40 includes a second coupling part 87. The second coupling part 87 is configured to be coupled to the first coupling part 86 to restrict the holder lid 40 from moving relative to the holder body 38 in the first direction D1 in the battery holding state where the battery 36 is provided in the holder space 42 and where the holder lid 40 is attached to the holder body 38. The first coupling part 86 and the second coupling part 87 have complementary shapes. In the present embodiment, the first coupling part 86 includes a coupling groove 86A. The second coupling part 87 includes an insertion portion 87A. The insertion portion 87A is configured to be provided in the coupling groove 86A.

The holder body 38 includes a third coupling part 88. The holder lid 40 includes a fourth coupling part 89. The fourth coupling part 89 is configured to be coupled to the third coupling part 88 to restrict the holder lid 40 from moving relative to the holder body 38 in the third direction D3 in the battery holding state where the battery 36 is provided in the holder space 42 and where the holder lid 40 is attached to the holder body 38. The third coupling part 88 and the fourth coupling part 89 have complementary shapes. In the present embodiment, the third coupling part 88 includes a coupling groove 88A. The fourth coupling part 89 includes an insertion portion 89A. The insertion portion 89A is configured to be provided in the coupling groove 88A.

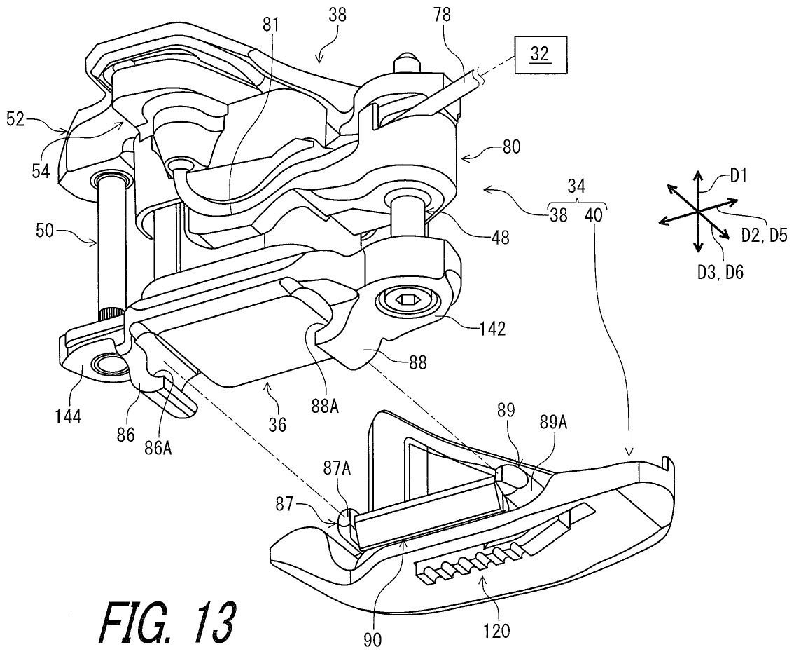

As seen in FIG. 13, the insertion portion 87A of the second coupling part 87 is configured to be inserted into the coupling groove 86A of the first coupling part 86 in the third direction D3 when the holder lid 40 is attached to the holder body 38. The insertion portion 89A of the fourth coupling part 89 is configured to be inserted into the coupling groove 88A of the third coupling part 88 in the third direction D3 when the holder lid 40 is attached to the holder body 38. The first coupling part 86 guides the second coupling part 87 in the third direction D3 when the holder lid 40 is attached to the holder body 38. The third coupling part 88 guides the fourth coupling part 89 in the third direction D3 when the holder lid 40 is attached to the holder body 38. The third coupling part 88 guides the fourth coupling part 89 in the third direction D3 while the holder lid 40 is attached to the holder body 38.

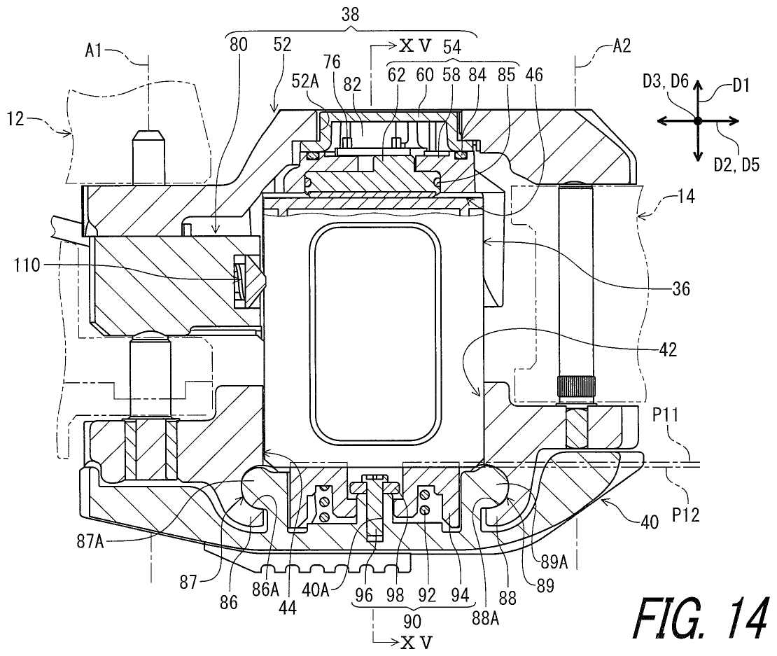

As seen in FIG. 14, the battery holder 34 further comprises a biasing structure 90. The biasing structure 90 can also be referred to as a first biasing structure 90. Namely, the battery holder 34 comprises the first biasing structure 90. The first biasing structure 90 is coupled to the holder lid 40 to bias the battery 36 toward the end portion 46 in a battery holding state where the battery 36 is provided in the holder space 42 and where the holder lid 40 is attached to the holder body 38. In the present embodiment, the first biasing structure 90 is coupled to the holder lid 40 to bias the battery 36 in the first direction D1 in the battery holding state. The first biasing structure 90 is provided separately from the holder lid 40. However, the first biasing structure 90 can be integrally provided with the holder lid 40 as a one-piece unitary member if needed and/or desired. The first biasing structure 90 can be provided to a member other than the holder lid 40 if needed and/or desired.

The first biasing structure 90 includes a first biasing member 92 and a first movable member 94. The first movable member 94 is movably coupled to the holder lid 40. The first biasing member 92 is configured to bias the first movable member 94 toward the end portion 46 in an attachment state where the holder lid 40 is attached to the holder body 38.

The first biasing member 92 is configured to bias the battery 36 via the first movable member 94 toward the end portion 46 in the battery holding state. The first biasing member 92 is at least partially provided between the first movable member 94 and the holder lid 40. The first biasing member 92 is configured to bias the battery 36 via the first movable member 94 toward the connector unit 54 in the battery holding state. In the present embodiment, the first biasing member 92 is entirely provided between the first movable member 94 and the holder lid 40. However, the first biasing member 92 can be partially provided between the first movable member 94 and the holder lid 40 if needed and/or desired.

As seen in FIG. 14, the first biasing structure 90 includes a fastener 96 and a positioning member 98. The positioning member 98 is fastened to the holder lid 40 with the fastener 96. For example, the fastener 96 includes a screw. The positioning member 98 includes a washer. The holder lid 40 includes a threaded hole 40A. The fastener 96 is threadedly engaged with the threaded hole of the holder lid 40.

The first movable member 94 is movable relative to the holder lid 40 between a first initial position P11 and a first holding position P12. The first movable member 94 is in the first initial position P11 in a first initial state where the first movable member 94 is in contact with the positioning member 98. The first movable member 94 is in the first holding position P12 in a first holding state where the first movable member 94 is in contact with the battery 36. The first movable member 94 is in the first initial position P11 in a state where the holder lid 40 is detached from the holder body 38. The first movable member 94 is in the first holding position P12 in the battery holding state.

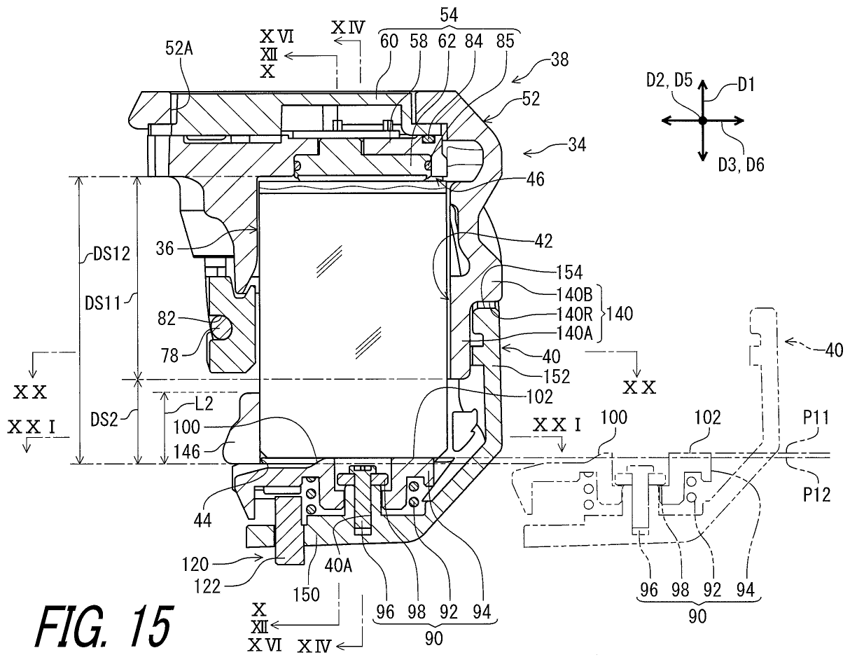

As seen in FIG. 15, the first movable member 94 includes a first inclined surface 100. The first inclined surface 100 is contactable with the battery 36. The first inclined surface 100 is non-perpendicular and non-parallel to the first direction D1. The first inclined surface 100 is inclined relative to the first direction D1. The first inclined surface 100 is contactable with the battery 36 to move the first movable member 94 relative to the holder lid 40 in response to attachment of the holder lid 40 to the holder body 38.

The first movable member 94 includes a first holding surface 102. The first holding surface 102 is contactable with the battery 36 in the attachment state where the holder lid 40 is attached to the holder body 38. The first inclined surface 100 is non-perpendicular to and non-parallel to the first holding surface 102. The first holding surface 102 is pressed against the battery 36 by the first biasing member 92 in the attachment state. However, the structure of the first movable member 94 is not limited to the illustrated embodiment.

As seen in FIG. 10, the battery holder 34 comprises a second biasing structure 110. The second biasing structure 110 is coupled to the holder body 38 to bias the battery 36 in the second direction D2 in a battery insertion state where the battery 36 is at least partially provided in the holder space 42.

The second biasing structure 110 includes a second biasing member 112 and a second movable member 114. The second movable member 114 is movably coupled to the holder body 38. The second biasing member 112 is configured to bias the second movable member 114 in the second direction D2. The second biasing member 112 is configured to bias the battery 36 in the second direction D2 via the second movable member 114 in the battery insertion state. The second biasing member 112 is configured to bias the second movable member 114 against the battery 36 in the second direction D2 in the battery insertion state.

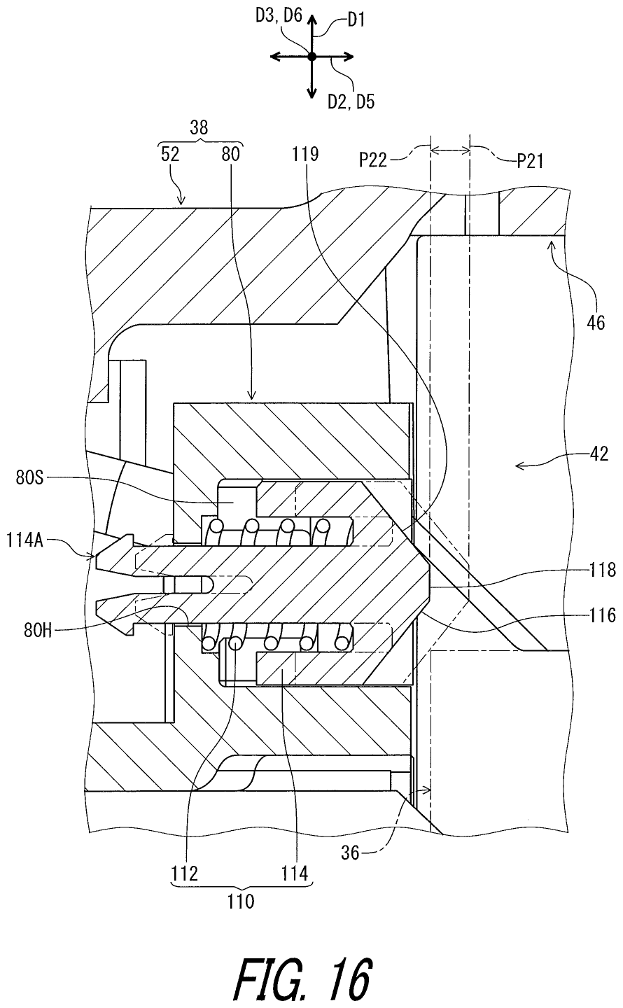

As seen in FIG. 16, the second biasing structure 110 is provided to the cable holder 80. The second movable member 114 is movably coupled to the cable holder 80. The cable holder 80 includes a support space 80S. The second movable member 114 is at least partially provided in the support space 80S. The second movable member 114 is movably provided in the support space 80S. The second biasing member 112 is at least partially provided in the support space 80S.

The cable holder 80 includes a support hole 80H. The support hole 80H is in communication with the support space 80S. The second movable member 114 extends through the support hole 80H. The second movable member 114 includes a stopper part 114A. The stopper part 114A is provided outside the support space 80S. The stopper part 114A is configured to restrict the second movable member 114 from falling off the support space 80S.

The second movable member 114 is movable relative to the holder body 38 between a second initial position P21 and a second holding position P22. The second movable member 114 is in the second initial position P21 in a second initial state where the stopper part 114A is in contact with the cable holder 80. The second movable member 114 is in the second holding position P22 in a second holding state where the second movable member 114 is in contact with the battery 36. The second movable member 114 is in the second initial position P21 in a state where the battery 36 is provided outside the holder space 42. The state where the battery 36 is provided outside the holder space 42 can also be referred to as a battery detachment state where the battery 36 is provided outside the holder space 42. The second movable member 114 is in the second holding position P22 in the battery detachment state.

The second biasing structure 110 is at least partially provided in the holder space 42 in the state where the battery 36 is provided outside the holder space 42. The second movable member 114 is at least partially provided in the holder space 42 in the battery detachment state.

In the present embodiment, the second biasing structure 110 is partially provided in the holder space 42 in the battery detachment state. The second movable member 114 is partially provided in the holder space 42 in the battery detachment state. However, the second biasing structure 110 can be entirely provided in the holder space 42 in the battery detachment state if needed and/or desired. The second movable member 114 can be entirely provided in the holder space 42 in the battery detachment state if needed and/or desired.

The second movable member 114 includes a second inclined surface 116. The second inclined surface 116 is contactable with the battery 36. The second inclined surface 116 is non-perpendicular and non-parallel to the second direction D2. The second inclined surface 116 is inclined relative to the second direction D2. The second inclined surface 116 is contactable with the battery 36 to move the second movable member 114 relative to the holder body 38 in response to the insertion of the battery 36 into the holder space 42.

The second movable member 114 includes a second holding surface 118. The second holding surface 118 is contactable with the battery 36 in the battery insertion state where the battery 36 is at least partially provided in the holder space 42. The second inclined surface 116 is non-perpendicular to and non-parallel to the second holding surface 118. The second holding surface 118 is pressed against the battery 36 by the second biasing member 112 in the battery insertion state. However, the structure of the second movable member 114 is not limited to the illustrated embodiment.

The second movable member 114 includes a second additional inclined surface 119. The second additional inclined surface 119 is non-perpendicular to and non-parallel to the second holding surface 118. The second additional inclined surface 119 is inclined relative to the second holding surface 118. The second holding surface 118 is provided between the second inclined surface 116 and the second additional inclined surface 119. The second additional inclined surface 119 can be perpendicular to or parallel to the second holding surface 118 if needed and/or desired. The second additional inclined surface 119 can be omitted from the second movable member 114 if needed and/or desired.

As seen in FIG. 10, the second biasing structure 110 is provided to the cable holder 80. The cable holder 80 includes an inner space. The second biasing structure 110 is at least partially provided in the inner space. The second biasing member 112 is at least partially provided in the inner space. The second movable member 114 is at least partially provided in the inner space. In the present embodiment, the second biasing structure 110 is partially provided in the inner space. The second biasing member 112 is entirely provided in the inner space. The second movable member 114 is partially provided in the inner space. However, the second biasing structure 110 can be entirely provided in the inner space if needed and/or desired. The second biasing member 112 can be partially provided in the inner space if needed and/or desired. The second movable member 114 can be entirely provided in the inner space if needed and/or desired.

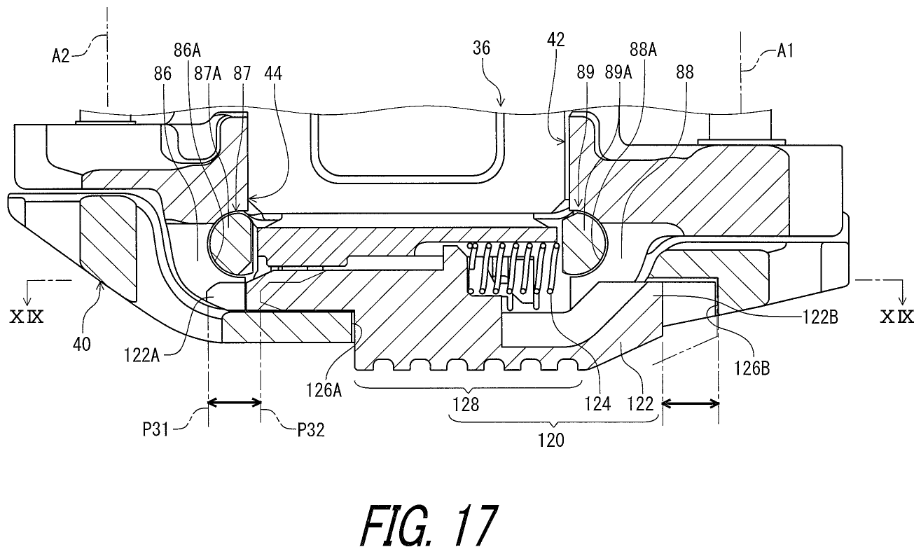

As seen in FIG. 17, the battery holder 34 further comprises a lock structure 120. The lock structure 120 is coupled to the holder lid 40 to restrict the holder lid 40 from being unintentionally detached from the holder body 38 in the attachment state where the holder lid 40 is attached to the holder body 38.

The lock structure 120 includes a lock member 122. The lock member 122 is movably coupled to the holder lid 40. The lock member 122 is movable relative to the holder lid 40 between a lock position P31 and an unlock position P32. In the lock position P31, the lock member 122 is configured to restrict the holder lid 40 from being unintentionally detached from the holder body 38 in the attachment state. In the unlock position P32, the lock member 122 is configured to allow the holder lid 40 to be detached from the holder body 38 in the attachment state.

The lock member 122 is movable relative to the holder lid 40 between the lock position P31 and the unlock position P32 in a lock operation direction D4. The lock member 122 includes a first longitudinal end 122A and a second longitudinal end 122B. The lock member 122 extends between the first longitudinal end 122A and the second longitudinal end 122B in the lock operation direction D4.

In the present embodiment, the lock operation direction D4 intersects with the third direction D3. The lock operation direction D4 is defined along the second direction D2. The lock operation direction D4 is perpendicular to the third direction D3. The lock operation direction D4 is parallel to the second direction D2. However, the lock operation direction D4 can be non-perpendicular to the third direction D3 if needed and/or desired. The lock operation direction D4 can be non-parallel to the second direction D2 if needed and/or desired.

The lock structure 120 includes a lock biasing member 124. The lock biasing member 124 is configured to bias the lock member 122 toward the lock position P31. The lock biasing member 124 is configured to bias the lock member 122 toward the lock position P31 while allowing the lock member 122 to move from the lock position P31 toward the unlock position P32. In the present embodiment, the lock biasing member 124 includes a spring. However, the lock biasing member 124 can include other members (e.g., elastomer such as rubber) instead of or in addition to the spring if needed and/or desired.

The lock biasing member 124 is provided between the lock member 122 and the holder lid 40. In the present embodiment, the lock biasing member 124 is provided between the lock member 122 and the insertion portion of the holder lid 40. However, the lock biasing member 124 can be provided in a position other than the position depicted in FIG. 17 if needed and/or desired.

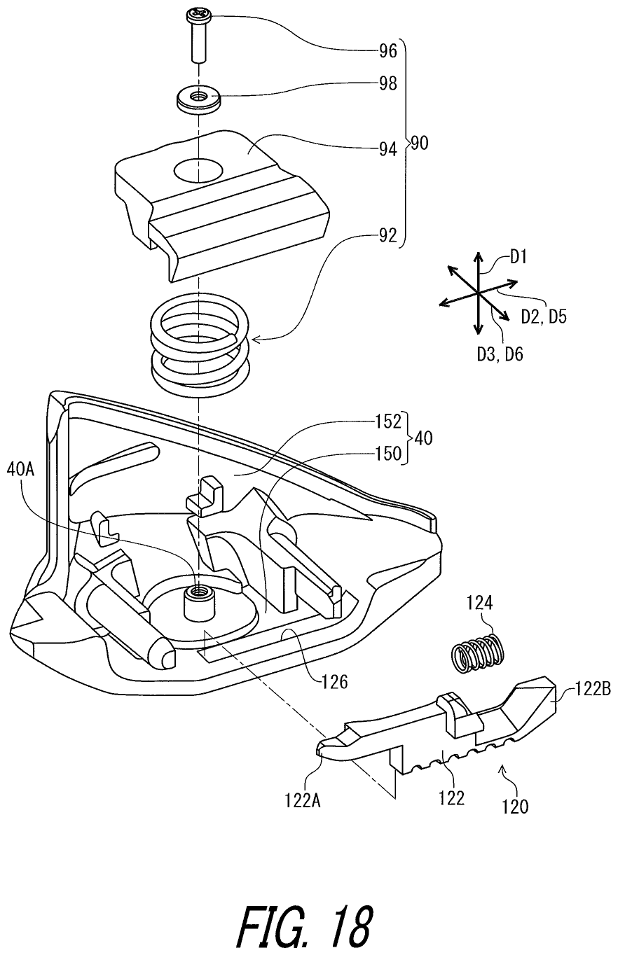

As seen in FIG. 18, the holder lid 40 includes a guide groove 126. The lock member 122 is at least partially provided in the guide groove 126. The guide groove 126 extends in the lock operation direction D4.

As seen in FIG. 17, the lock member 122 is movably provided in the guide groove 126 in the lock operation direction D4. The holder lid 40 includes a first groove end 126A and a second groove end 126B. The guide groove 126 is provided between the first groove end 126A and the second groove end 126B. The lock member 122 is in contact with the first groove end 126A in a lock state where the lock member 122 is in the lock position P31. The lock member 122 is in contact with the second groove end 126B in an unlock state where the lock member 122 is in the unlock position P32.

The lock member 122 includes a slip reduction part 128 configured to be operated by the user. The slip reduction part 128 is at least partially provided outside the guide groove 126. The slip reduction part 128 includes at least one of a protrusion and a recess. In the present embodiment, the slip reduction part 128 includes at least two protrusions and at least two recesses. The recess is provided between two adjacent protrusions of the at least two protrusions. However, the structure of the slip reduction part 128 is not limited to the illustrated embodiment.

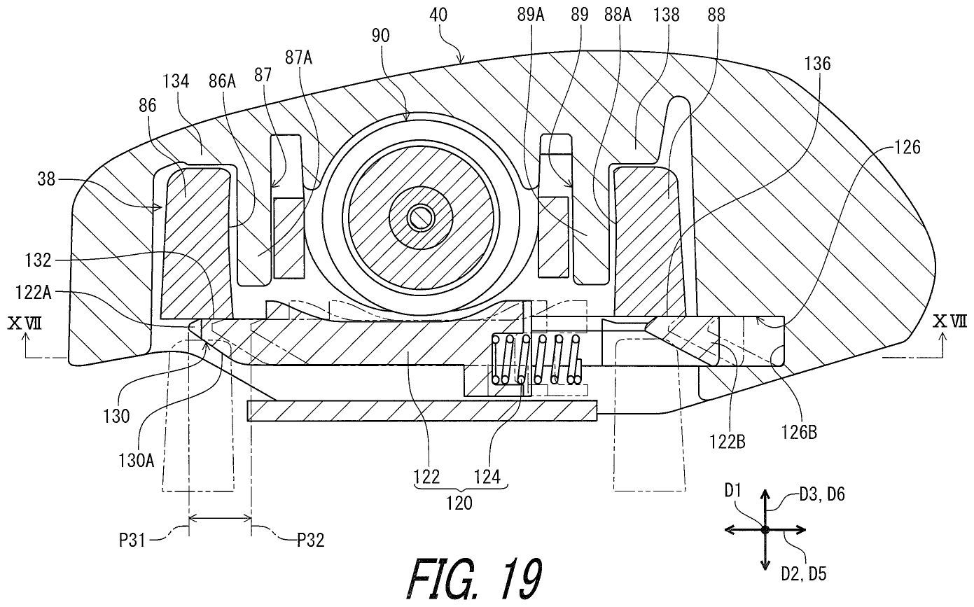

As seen in FIG. 19, the lock member 122 is movable relative to the holder body 38 between the lock position P31 and the unlock position P32 in response to attachment of the holder lid 40 to the holder body 38.

In the present embodiment, the lock member 122 includes a contact surface 130. The contact surface 130 is contactable with the holder body 38 to move the lock member 122 from the lock position P31 to the unlock position P32 in response to the attachment of the holder lid 40 to the holder body 38. The contact surface 130 is contactable with the first coupling part 86 to move the lock member 122 from the lock position P31 to the unlock position P32 in response to the attachment of the holder lid 40 to the holder body 38.

In the present embodiment, the contact surface 130 includes an inclined surface 130A. The inclined surface 130A is non-perpendicular and non-parallel to the third direction D3. The inclined surface 130A is inclined relative to the third direction D3. However, the contact surface 130 can have other shapes if needed and/or desired.

The lock member 122 includes a lock surface 132. The lock surface 132 is contactable with the holder lid 40 in the attachment state. The lock surface 132 is provided on a reverse side of the contact surface 130. The lock surface 132 is perpendicular to the third direction D3. The lock surface 132 is contactable with the holder body 38 to restrict the lock member 122 from moving from the lock position P31 toward the unlock position P32 in the attachment state.

The holder lid 40 includes a holding end part 134. The holding end part 134 is contactable with the first coupling part 86 in the attachment state. The first coupling part 86 is at least partially provided between the holding end part 134 and the lock member 122 in the third direction D3. The first coupling part 86 is at least partially provided between the holding end part 134 and the lock surface 132 in the third direction D3. Thus, the holder lid 40 is locked by the lock member 122 in the attachment state, restricting the holder lid 40 from falling off from the holder body 38.

The lock member 122 includes an additional lock surface 136. The additional lock surface 136 is contactable with the holder lid 40 in the attachment state. The additional lock surface 136 is provided on a reverse side of the contact surface 130. The additional lock surface 136 is perpendicular to the third direction D3. The additional lock surface 136 is contactable with the holder body 38 to restrict the lock member 122 from moving from the lock position P31 toward the unlock position P32 in the attachment state.

The holder lid 40 includes an additional holding end part 138. The additional holding end part 138 is contactable with the third coupling part 88 in the attachment state. The third coupling part 88 is at least partially provided between the additional holding end part 138 and the lock member 122 in the third direction D3. The third coupling part 88 is at least partially provided between the additional holding end part 138 and the additional lock surface 136 in the third direction D3. Thus, the holder lid 40 is reliably locked by the lock member 122 in the attachment state, restricting reliably the holder lid 40 from falling off the holder body 38.

When the lock member 122 is moved by the user from the lock position P31 to the unlock position P32, the first coupling part 86 can be moved outwardly from the space between the lock member 122 and the holding end part 134, and the third coupling part 88 can be moved outwardly from the space between the lock member 122 and the additional holding end part 138. Thus, the holder lid 40 can be detached from the holder body 38 using the lock member 122.

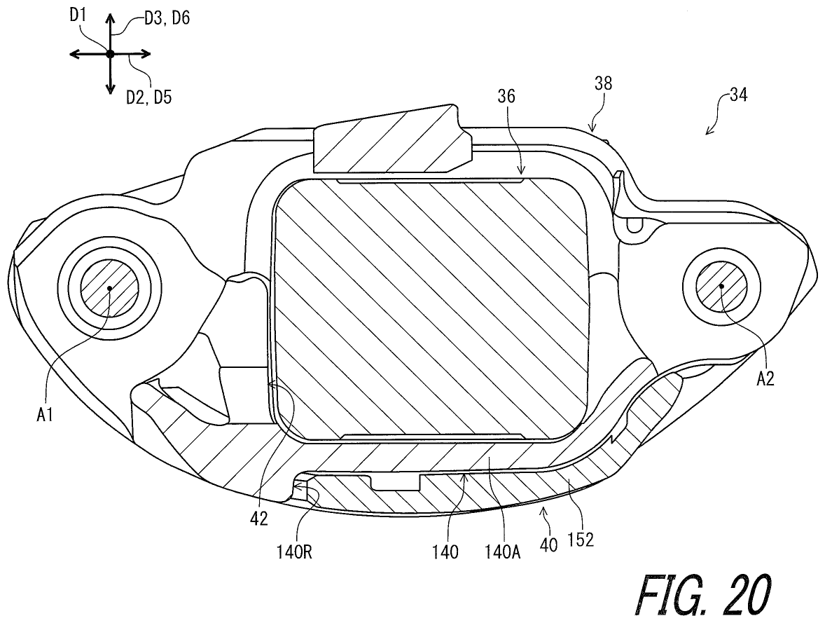

As seen in FIG. 20, the holder body 38 includes a side wall 140. The side wall 140 partially defines the holder space 42. The holder lid 40 is configured to cover the side wall 140 at least partially in the attachment state where the holder lid 40 is attached to the holder body 38. In the present embodiment, the holder lid 40 is configured to cover the side wall 140 partially in the attachment state. However, the holder lid 40 can be configured to cover the side wall 140 entirely in the attachment state.

The side wall 140 is at least partially provided between the holder lid 40 and the battery 36 in the battery holding state where the battery 36 is provided in the holder space 42 and where the holder lid 40 is attached to the holder body 38. In the present embodiment, the side wall 140 is partially provided between the holder lid 40 and the battery 36 in the battery holding state. However, the side wall 140 can be entirely provided between the holder lid 40 and the battery 36 in the battery holding state if needed and/or desired.

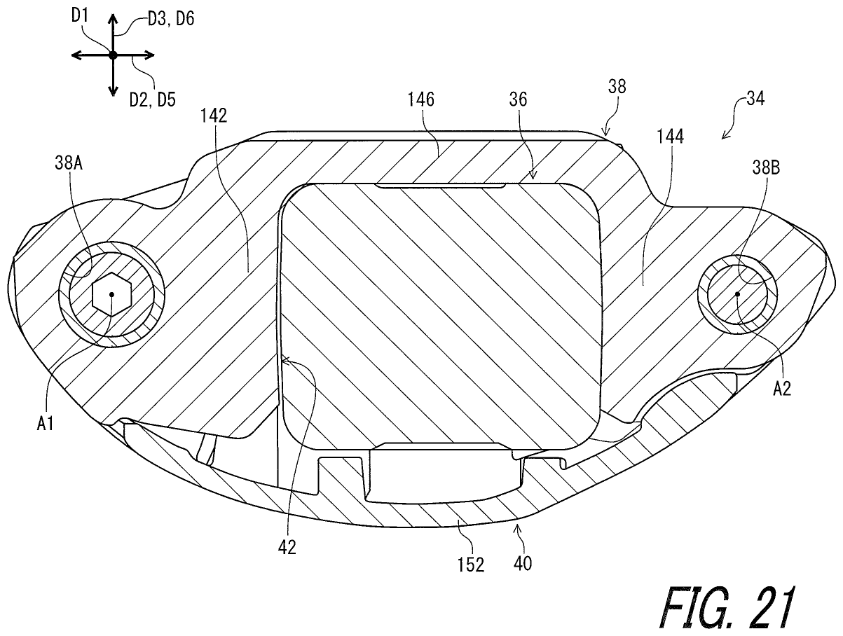

As seen in FIG. 21, the holder body 38 includes a first part 142, a second part 144, and a third part 146. The first part 142, the second part 144, and the third part 146 at least partially define the insertion opening 44. The first part 142 is spaced apart from the third part 146. The second part 144 couples the first part 142 and the third part 146. The first part 142 includes the first hole 38A. The second part 144 includes the second hole 38B.

As seen in FIG. 9, the side wall 140 is coupled to the first part 142, the second part 144, and the third part 146. The first coupling part 86 is provided to the second part 144. The third coupling part 88 is provided to the first part 142. The first coupling part 86 protrudes form the second part 144 in the first direction D1. The third coupling part 88 protrudes from the first part 142 in the first direction D1.

As seen in FIG. 15, the side wall 140 is spaced apart from the second part 144 in the third direction D3. A first maximum distance DS11 is defined between the end portion 46 and the side wall 140 in the first direction D1. A second maximum distance DS12 is defined between the end portion 46 and the second part 144 in the first direction D1. In the present embodiment, the first maximum distance DS11 is shorter than the second maximum distance DS12. However, the first maximum distance DS11 can be longer than or equal to the second maximum distance DS12 if needed and/or desired.

A minimum distance DS2 is defined between the insertion opening 44 and the side wall 140 in the first direction D1. A length L2 is defined between the insertion opening 44 and the third part 146 in the first direction D1. In the present embodiment, the minimum distance DS2 is longer than the length L2 in the first direction D1. However, the minimum distance DS2 can be shorter than or equal to the length L2 in the first direction D1. In such modifications, for example, the side wall 140 can define the insertion opening 44 along with the first part 142, the second part 144, and the third part 146 if needed and/or desired. The side wall 140 can include a portion which is spaced apart from the third part 146 in the third direction D3 and which define the insertion opening 44 along with the first part 142, the second part 144, and the third part 146.

As seen in FIG. 2, the mounting portion 18 is attached to the vehicle body 2A in a mounting state where the battery holder 34 is mounted to the vehicle body 2A of the human-powered vehicle 2. The holder lid 40 is at least partially provided below the holder body 38 in the mounting state where the battery holder 34 is mounted to the vehicle body 2A of the human-powered vehicle 2. In the present embodiment, the holder lid 40 is partially provided below the holder body 38 in the mounting state. However, the holder lid 40 can be entirely provided below the holder body 38 in the mounting state if needed and/or desired.

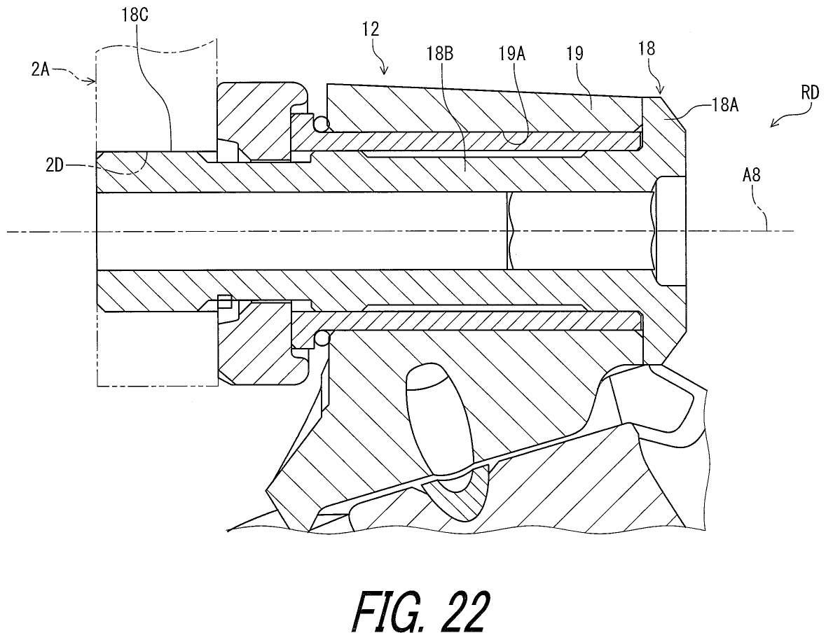

As seen in FIG. 22, the mounting portion 18 includes a mounting hole 19A. The derailleur fastener 17 extends through the mounting hole 19A. The derailleur fastener 17 includes a head portion 18A and an extending portion 18B. The extending portion 18B extends from the head portion 18A along the fastener center axis A8. The extending portion 18B extends through the mounting hole 19A. The extending portion 18B includes an externally threaded portion 18C. The externally threaded portion 18C is threaded engaged with a threaded hole 2D of the vehicle body 2A.

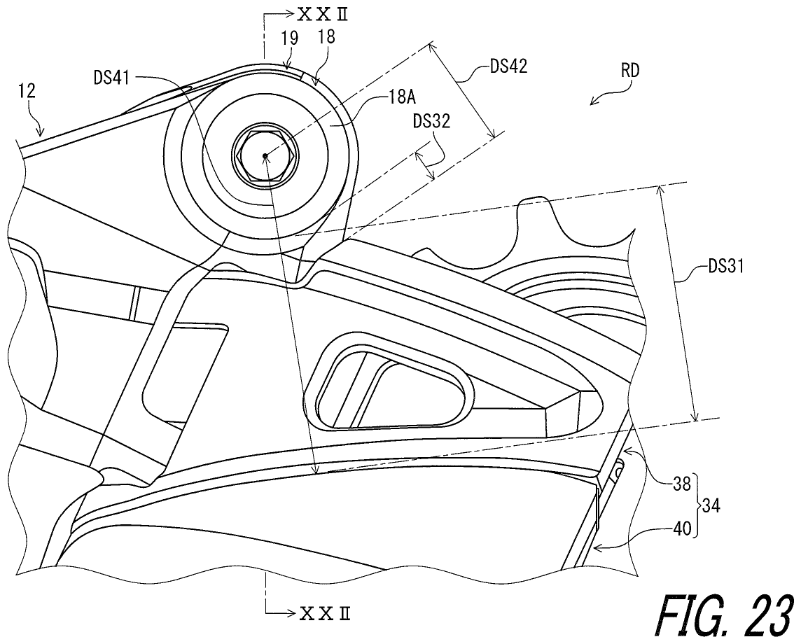

As seen in FIG. 23, the holder lid 40 is at least partially provided farther from the mounting portion 18 than the holder body 38 in the mounting state where the battery holder 34 is mounted to the vehicle body 2A of the human-powered vehicle 2. The holder lid 40 is at least partially provided farther from the fastener center axis A8 than the holder body 38 as viewed along the fastener center axis A8 in the mounting state.

In the present embodiment, the holder lid 40 is partially provided farther from the mounting portion 18 than the holder body 38 in the mounting state. The holder lid 40 is partially provided farther from the fastener center axis A8 than the holder body 38 as viewed along the fastener center axis A8 in the mounting state. However, the holder lid 40 can be entirely provided farther from the mounting portion 18 than the holder body 38 in the mounting state if needed and/or desired. The holder lid 40 can be entirely provided farther from the fastener center axis A8 than the holder body 38 as viewed along the fastener center axis A8 in the mounting state if needed and/or desired.

A first minimum distance DS31 is defined between the mounting portion 18 and the holder lid 40 as viewed along the fastener center axis A8. A second minimum distance DS32 is defined between the mounting portion 18 and the holder body 38 as viewed along the fastener center axis A8. In the present embodiment, the first minimum distance DS31 is longer than the second minimum distance DS32. However, the first minimum distance DS31 can be shorter than or equal to the second minimum distance DS32 as viewed along the fastener center axis A8 if needed and/or desired.

A first minimum distance DS41 is defined between the fastener center axis A8 and the holder lid 40 as viewed along the fastener center axis A8. A second minimum distance DS42 is defined between the fastener center axis A8 and the holder body 38 as viewed along the fastener center axis A8. In the present embodiment, the first minimum distance DS41 is longer than the second minimum distance DS42. However, the first minimum distance DS41 can be shorter than or equal to the second minimum distance DS42 as viewed along the fastener center axis A8 if needed and/or desired.

As seen in FIG. 4, the holder lid 40 is at least partially provided farther from the transverse center plane CP of the vehicle body 2A of the human-powered vehicle 2 than the holder body 38 in a derailleur mounting state where the bicycle component RD is mounted to the vehicle body 2A of the human-powered vehicle 2. In the present embodiment, the holder lid 40 is partially provided farther from the transverse center plane CP of the vehicle body 2A of the human-powered vehicle 2 than the holder body 38 in the derailleur mounting state. However, the holder lid 40 can be entirely provided farther from the transverse center plane CP of the vehicle body 2A of the human-powered vehicle 2 than the holder body 38 in the derailleur mounting state.

As seen in FIG. 18, the holder lid 40 includes a battery receiving portion 150 and a cover portion 152. The battery receiving portion 150 is configured to receive the battery 36 in the battery holding state where the battery 36 is provided in the holder space 42 and where the holder lid 40 is attached to the holder body 38. The first biasing structure 90 is mounted to the battery receiving portion 150. The battery receiving portion 150 includes the threaded hole 40A. The first movable member 94 is movably coupled to the battery receiving portion 150 with the fastener 96.

As seen in FIG. 15, the cover portion 152 protrudes from the battery receiving portion 150 in the first direction D1 in the attachment state. The cover portion 152 protrudes from the battery receiving portion 150 to cover the side wall 140 at least partially in the attachment state. The side wall 140 is configured to be at least partially provided between the battery 36 and the cover portion 152 in the battery holding state.

In the present embodiment, the cover portion 152 protrudes from the battery receiving portion 150 to cover the side wall 140 partially in the attachment state. The side wall 140 is configured to be partially provided between the battery 36 and the cover portion 152 in the battery holding state. However, the cover portion 152 can be arranged to protrude from the battery receiving portion 150 to cover the side wall 140 entirely in the attachment state if needed and/or desired. The side wall 140 can be configured to be entirely provided between the battery 36 and the cover portion 152 in the battery holding state if needed and/or desired.

The cover portion 152 includes a cover end part 154. The cover portion 152 extends from the battery receiving portion 150 to the cover end part 154 beyond the insertion opening 44 in the first direction D1.

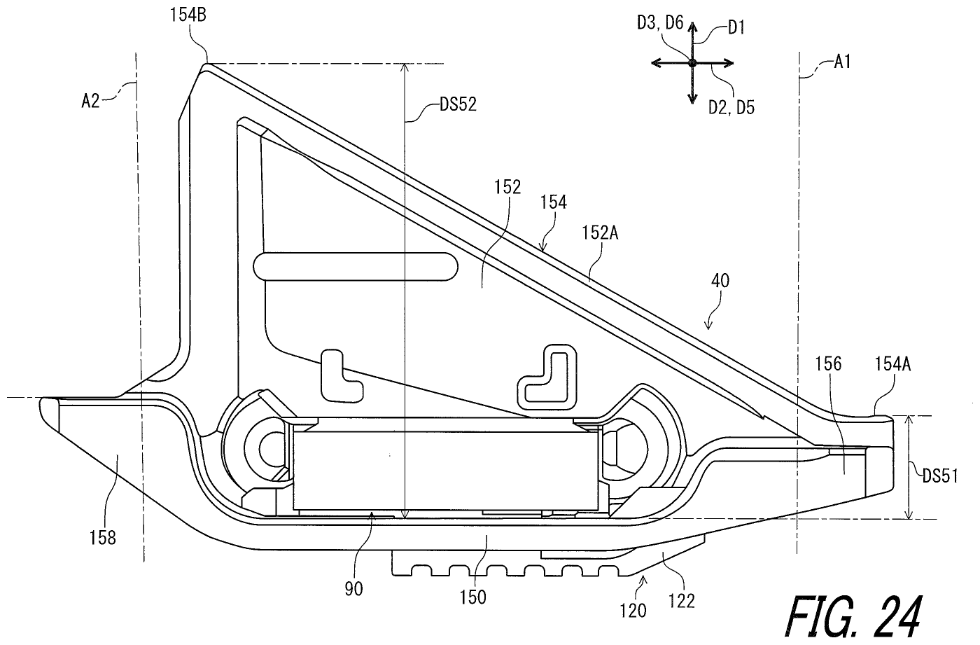

As seen in FIG. 24, the cover end part 154 includes a first end part 154A and a second end part 154B. A first distance DS51 is defined between the first end part 154A and the battery receiving portion 150 in the first direction D1. A second distance DS52 is defined between the second end part 154B and the battery receiving portion 150 in the first direction D1. In the present embodiment, the first distance DS51 is different from the second distance DS52. The second distance DS52 is defined as a maximum distance between the cover end part 154 and the battery receiving portion 150 in the first direction D1. The second distance DS52 is longer than the first distance DS51. However, the second distance DS52 can be shorter than or equal to the first distance DS51 if needed and/or desired.

The first pivot axis A1 is spaced apart from the second pivot axis A2 in a fifth direction D5 different from the first direction D1. The fifth direction D5 intersects with the first direction D1. In the present embodiment, the fifth direction D5 is perpendicular to the first direction D1. The fifth direction D5 is parallel to the second direction D2. However, the fifth direction D5 can be non-perpendicular to the first direction D1 if needed and/or desired. The fifth direction D5 can be non-parallel to the second direction D2 if needed and/or desired.

The first end part 154A is provided closer to the first pivot axis A1 than the second end part 154B in the fifth direction D5. The second end part 154B is provided closer to the second pivot axis A2 than the first end part 154A in the fifth direction D5. The first end part 154A is provided closer to the first pivot axis A1 than the second end part 154B in the fifth direction D5 as viewed in the third direction D3. The second end part 154B is provided closer to the second pivot axis A2 than the first end part 154A in the fifth direction D5 as viewed in the third direction D3. However, the positional relationship between the first end part 154A, the second end part 154B, the first pivot axis A1, and the second pivot axis A2 is not limited to the illustrated embodiment.

The cover portion 152 is at least partially provided between the first pivot axis A1 and the second pivot axis A2 in the fifth direction D5 as viewed in a sixth direction D6. In the present embodiment, the cover portion 152 is partially provided between the first pivot axis A1 and the second pivot axis A2 in the fifth direction D5 as viewed in the sixth direction D6. However, the cover portion 152 can be entirely provided between the first pivot axis A1 and the second pivot axis A2 in the fifth direction D5 as viewed in the sixth direction D6 if needed and/or desired.

The sixth direction D6 is perpendicular to the first direction D1 and the fifth direction D5. The sixth direction D6 is parallel to the third direction D3. However, the sixth direction D6 can be non-parallel to the third direction D3 if needed and/or desired. The sixth direction D6 can be non-perpendicular to at least one of the first direction D1 and the fifth direction D5 if needed and/or desired.

The cover portion 152 includes an inclined end surface 152A. The cover end part 154 includes the inclined end surface 152A. The inclined end surface 152A extends between the first end part 154A and the second end part 154B. The cover portion 152 extends from the battery receiving portion 150 to the inclined end surface 152A in the first direction D1. The inclined end surface 152A is non-perpendicular to and non-parallel to the first direction D1. The inclined end surface 152A is inclined relative to the first direction D1. However, the cover end part 154 can include a surface which is perpendicular to or parallel to the first direction D1 if needed and/or desired.

As seen in FIGS. 15 and 20, the side wall 140 includes a recess 140R. The cover portion 152 is configured to be at least partially provided in the recess 140R in the attachment state. In the present embodiment, the cover portion 152 is configured to be partially provided in the recess 140R in the attachment state. However, the cover portion 152 can be configured to be entirely provided in the recess 140R in the attachment state if needed and/or desired.

As seen in FIG. 15, the side wall 140 includes a wall portion 140A and a protruding portion 140B. The protruding portion 140B protrudes from the wall portion 140A away from the holder space 42. The wall portion 140A and the protruding portion 140B define the recess 140R.

The protruding portion 140B includes an additional inclined end surface 140C. The additional inclined end surface 140C is non-perpendicular to and non-parallel to the first direction D1. The additional inclined end surface 140C is inclined relative to the first direction D1. The inclined end surface 152A is configured to face the additional inclined end surface 140C in the attachment state.

As seen in FIG. 10, the holder lid 40 is configured to cover at least one of the first pin end 48A and the second pin end 50A at least partially in the attachment state. In the present embodiment, the holder lid 40 is configured to cover the first pin end 48A entirely in the attachment state. The holder lid 40 is configured to cover the second pin end 50A entirely in the attachment state. However, the holder lid 40 can be configured to cover the first pin end 48A partially in the attachment state if needed and/or desired. The holder lid 40 can be configured to cover the second pin end 50A partially in the attachment state if needed and/or desired.

The holder lid 40 is configured to cover at least one of the first hole 38A and the second hole 38B at least partially in the attachment state. In the present embodiment, the first pin end 48A is entirely provided in the first hole 38A. The second pin end 50A is entirely provided in the second hole 38B. The holder lid 40 is configured to cover the first hole 38A entirely in the attachment state. The holder lid 40 is configured to cover the second hole 38B at least entirely in the attachment state. However, the first pin end 48A can be partially provided in the first hole 38A if needed and/or desired. The second pin end 50A can be partially provided in the second hole 38B if needed and/or desired. The holder lid 40 can be configured to cover the first hole 38A partially in the attachment state if needed and/or desired. The holder lid 40 can be configured to cover the second hole 38B at least partially in the attachment state if needed and/or desired.

The holder lid 40 includes a first facing part 156 and a second facing part 158. The first facing part 156 extends from the battery receiving portion 150 in the fifth direction D5. The second facing part 158 extends from the battery receiving portion 150 in the fifth direction D5. The first facing part 156 faces the first pin end 48A of the first pivot pin 48 in the first direction D1 in the attachment state where the holder lid 40 is attached to the holder body 38. The second facing part 158 faces the second pin end 50A of the second pivot pin 50 in the first direction D1 in the attachment state. The first facing part 156 faces the first hole 38A in the first direction D1 in the attachment state. The second facing part 158 faces the second hole 38B in the first direction D1 in the attachment state. However, at least one of the first facing part 156 and the second facing part 158 can be omitted from the holder lid 40 if needed and/or desired.

As seen in FIG. 10, the holder space 42 is at least partially provided between the end portion 46 and the battery receiving portion 150 in the first direction D1 in the attachment state. The biasing structure 90 is coupled to the battery receiving portion 150 to bias the battery 36 toward the end portion 46 in the battery holding state. The biasing structure 90 is configured to be at least partially provided between the battery 36 and the battery receiving portion 150 in the battery holding state.

In the present embodiment, the holder space 42 is entirely provided between the end portion 46 and the battery receiving portion 150 in the first direction D1 in the attachment state. The biasing structure 90 is configured to be entirely provided between the battery 36 and the battery receiving portion 150 in the battery holding state. However, the holder space 42 can be partially provided between the end portion 46 and the battery receiving portion 150 in the first direction D1 in the attachment state if needed and/or desired. The biasing structure 90 can be configured to be partially provided between the battery 36 and the battery receiving portion 150 in the battery holding state if needed and/or desired.

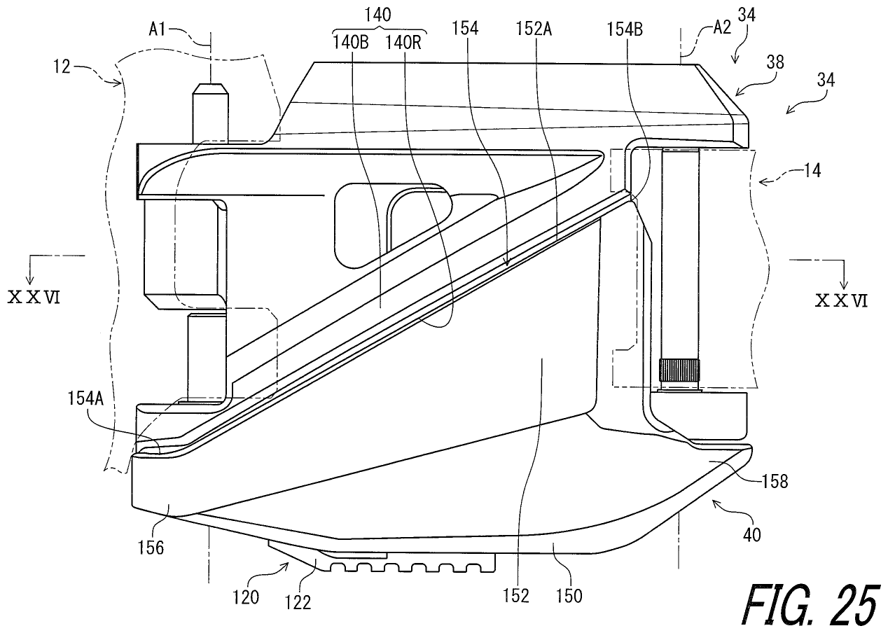

As seen in FIG. 25, the holder lid 40 is arranged to overlap the movable member 14 at least partially as viewed in the third direction D3. The holder lid 40 is arranged to overlap the coupling member 20 at least partially as viewed in the third direction D3. The cover portion 152 is arranged to overlap the movable member 14 at least partially as viewed in the third direction D3. The cover portion 152 is arranged to overlap the coupling member 20 at least partially as viewed in the third direction D3.

In the present embodiment, the holder lid 40 is arranged to overlap the movable member 14 partially as viewed in the third direction D3. The holder lid 40 is arranged to overlap the coupling member 20 partially as viewed in the third direction D3. The cover portion 152 is arranged to overlap the coupling member 20 partially as viewed in the third direction D3. However, the holder lid 40 can be arranged to overlap the movable member 14 entirely as viewed in the third direction D3 if needed and/or desired. The holder lid 40 can be arranged to overlap the coupling member 20 entirely as viewed in the third direction D3 if needed and/or desired. The cover portion 152 can be arranged to overlap the movable member 14 entirely as viewed in the third direction D3 if needed and/or desired. The cover portion 152 can be arranged to overlap the coupling member 20 entirely as viewed in the third direction D3 if needed and/or desired.

Furthermore, the holder lid 40 can be arranged not to overlap the movable member 14 as viewed in the third direction D3 if needed and/or desired. The holder lid 40 can be arranged not to overlap the coupling member 20 as viewed in the third direction D3 if needed and/or desired. The cover portion 152 can be arranged not to overlap the movable member 14 as viewed in the third direction D3 if needed and/or desired. The cover portion 152 can be arranged not to overlap the coupling member 20 as viewed in the third direction D3 if needed and/or desired.

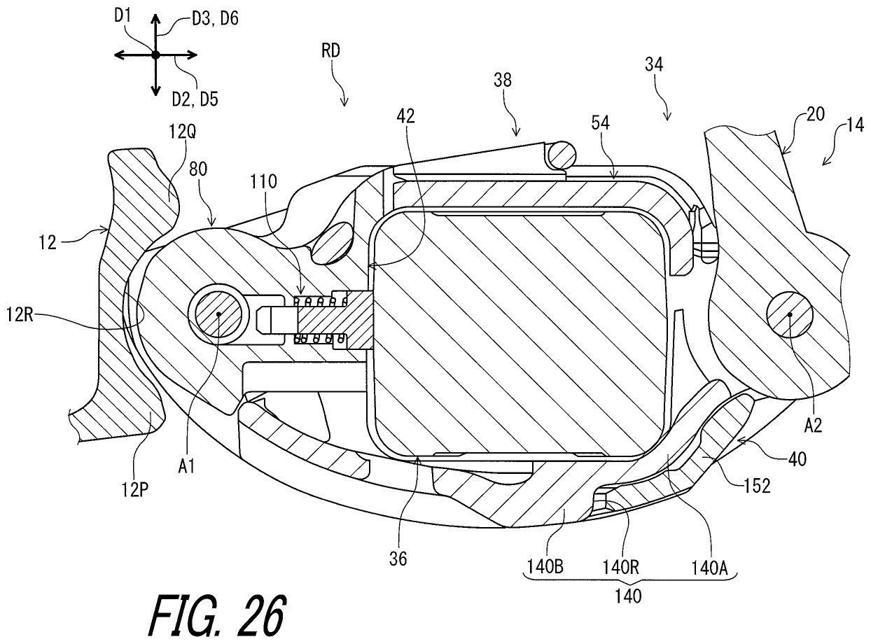

As seen in FIG. 26, the base member 12 includes a first protruding portion 12P, a second protruding portion 12Q, and a recess 12R. The recess 12R is provided between the first protruding portion 12P and the second protruding portion 12Q. The holder body 38 is partially provided in the recess 12R. The holder body 38 is partially provided between the first protruding portion 12P and the second protruding portion 12Q. The cable holder 80 is partially provided in the recess 12R. The cable holder 80 is partially provided between the first protruding portion 12P and the second protruding portion 12Q.

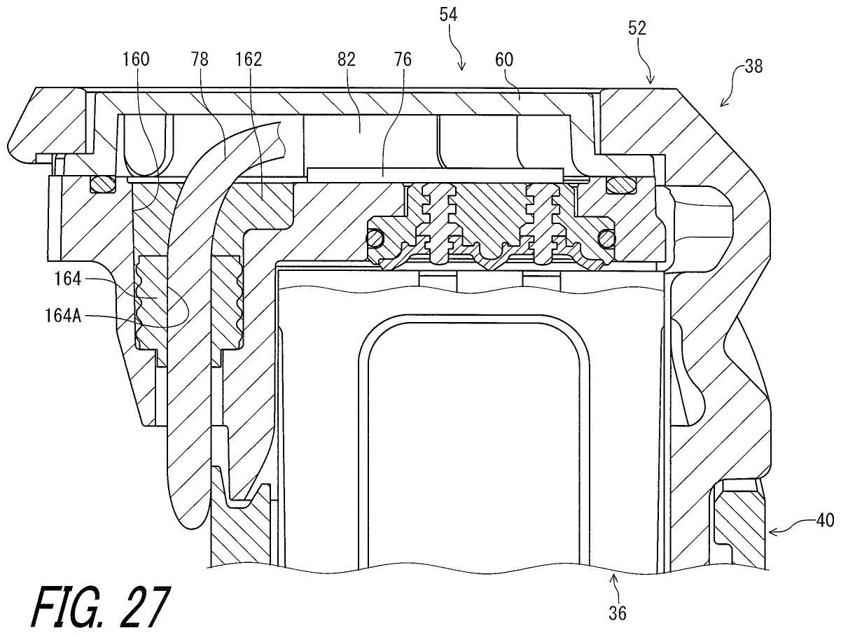

As seen in FIG. 27, the holder body 38 includes a cable opening 160 through which the electrical cable 78 extends. The connector base 58 includes the cable opening 160. The connector unit 54 includes a first inner member 162 and a second inner member 164. The first inner member 162 and the second inner member 164 are provided in the cable opening 160. The first inner member 162 is made of a resin material. The second inner member 164 includes a hole 164A through which the electrical cable 78 extends. Examples of the resin material include ultraviolet curing resin. The space 82 is sealed by the first inner member 162 and the second inner member 164. The electrical cable 78 and the second inner member 164 are secured to the holder body 38 by the first inner member 162. However, the structure of the connector unit 54 is not limited to the illustrated embodiment.

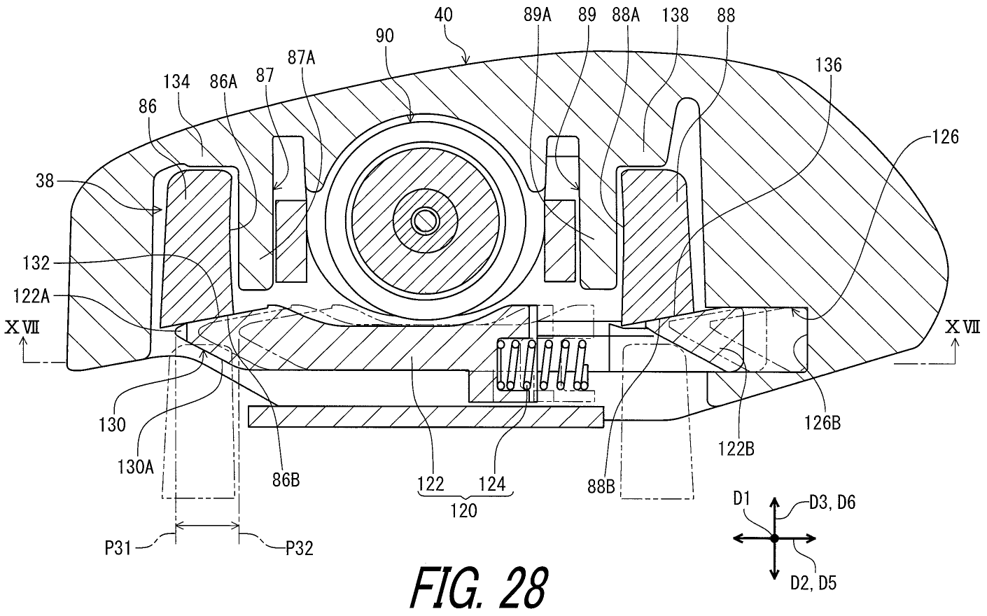

As seen in FIG. 28, the lock surface 132 can be non-parallel to each of the second direction D2, the third direction D3, the fifth direction D5, and the sixth direction D6 if needed and/or desired. The additional lock surface 136 can be non-parallel to each of the second direction D2, the third direction D3, the fifth direction D5, and the sixth direction D6 if needed and/or desired. In the modification depicted in FIG. 28, the lock surface 132 is non-perpendicular to and non-parallel to each of the second direction D2, the third direction D3, the fifth direction D5, and the sixth direction D6. The additional lock surface 136 is non-perpendicular to and non-parallel to each of the second direction D2, the third direction D3, the fifth direction D5, and the sixth direction D6. The lock surface 132 is inclined relative to each of the second direction D2, the third direction D3, the fifth direction D5, and the sixth direction D6. The additional lock surface 136 is inclined relative to each of the second direction D2, the third direction D3, the fifth direction D5, and the sixth direction D6. The first coupling part 86 includes an inclined surface 86B contactable with the lock surface 132. The third coupling part 88 includes an inclined surface 88B contactable with the additional lock surface 136. The inclined surface 86B is non-perpendicular to and non-parallel to each of the second direction D2, the third direction D3, the fifth direction D5, and the sixth direction D6. The inclined surface 88B is non-perpendicular to and non-parallel to each of the second direction D2, the third direction D3, the fifth direction D5, and the sixth direction D6. The inclined surface 86B is inclined relative to each of the second direction D2, the third direction D3, the fifth direction D5, and the sixth direction D6. The inclined surface 88B is inclined relative to each of the second direction D2, the third direction D3, the fifth direction D5, and the sixth direction D6. The lock biasing member 124 biases the lock member 122 such that the lock surface 132 presses the first coupling part 86 toward the holding end part 134. The lock biasing member 124 biases the lock member 122 such that the additional lock surface 136 presses the third coupling part 88 toward the additional holding end part 138. This modification makes the attachment state of the holder lid 40 more stable.

The structure of the battery holder 34 described in each of the above embodiments and modifications thereof can be applied to any bicycle component such as the bicycle component RD, the bicycle component FD, a suspension, and an adjustable seatpost except for an assist drive unit of the electric bike.

In the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “pair of,” as used herein, can encompass the configuration in which the pair of elements have different shapes or structures from each other in addition to the configuration in which the pair of elements have the same shapes or structures as each other.

The terms “a” (or “an”), “one or more” and “at least one” can be used interchangeably herein.

The phrase “at least one of” as used in this disclosure means “one or more” of a desired choice. For one example, the phrase “at least one of” as used in this disclosure means “only one single choice” or “both of two choices” if the number of its choices is two. For other example, the phrase “at least one of” as used in this disclosure means “only one single choice” or “any combination of equal to or more than two choices” if the number of its choices is equal to or more than three. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Finally, terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Obviously, numerous modifications and variations of the present invention are possible in light of the above teachings. It is therefore to be understood that within the scope of the appended claims, the invention may be practiced otherwise than as specifically described herein.

What is claimed is:

1. A battery holder comprising:
a holder body including a holder space in which a battery is configured to be at least partially provided, the holder space including an insertion opening through which the battery is configured to pass in a first direction, the holder body including a side wall partially defining the holder space; and
a holder lid attachable to the holder body to cover the insertion opening at least partially, the holder lid being configured to cover the side wall at least partially in an attachment state where the holder lid is attached to the holder body.

2. The battery holder according to claim 1, wherein
the holder lid includes a battery receiving portion and a cover portion,
the battery receiving portion is configured to receive the battery in a battery holding state where the battery is provided in the holder space and where the holder lid is attached to the holder body, and
the cover portion protrudes from the battery receiving portion to cover the side wall at least partially in the attachment state.

3. The battery holder according to claim 2, wherein
the side wall is configured to be at least partially provided between the battery and the cover portion in the battery holding state.

4. The battery holder according to claim 2, wherein
the cover portion protrudes from the battery receiving portion in the first direction in the attachment state.

5. The battery holder according to claim 2, wherein
the cover portion includes a cover end part, and
the cover portion extends from the battery receiving portion to the cover end part beyond the insertion opening in the first direction.

6. The battery holder according to claim 5, wherein
the cover end part includes a first end part and a second end part,
a first distance is defined between the first end part and the battery receiving portion in the first direction,
a second distance is defined between the second end part and the battery receiving portion in the first direction, and
the first distance is different from the second distance.

7. The battery holder according to claim 6, wherein
the second distance is defined as a maximum distance between the cover end part and the battery receiving portion in the first direction.

8. The battery holder according to claim 6, wherein
the holder body is configured to be pivotally coupled to a base member about a first pivot axis,
the holder body is configured to be pivotally coupled to a movable member about a second pivot axis,
the first pivot axis is spaced apart from the second pivot axis in a fifth direction different from the first direction,
the first end part is provided closer to the first pivot axis than the second end part in the fifth direction,
the second end part is provided closer to the second pivot axis than the first end part in the fifth direction, and
the second distance is longer than the first distance.

9. The battery holder according to claim 8, wherein
the cover end part includes an inclined end surface,
the inclined end surface extends between the first end part and the second end part, and
the inclined end surface is non-perpendicular to and non-parallel to the first direction.

10. The battery holder according to claim 2, wherein
the holder body is configured to be pivotally coupled to a base member about a first pivot axis,
the holder body is configured to be pivotally coupled to a movable member about a second pivot axis,
the first pivot axis is spaced apart from the second pivot axis in a fifth direction different from the first direction, and
the cover portion is at least partially provided between the first pivot axis and the second pivot axis in the fifth direction as viewed in a sixth direction, the sixth direction being perpendicular to the first direction and the fifth direction.

11. The battery holder according to claim 10, further comprising:
a first pivot pin configured to pivotally couple the holder body and the base member about the first pivot axis, the first pivot pin including a first pin end and a first additional pin end and extending between the first pin end and the first additional pin end along the first pivot axis; and
a second pivot pin configured to pivotally couple the holder body and the movable member about the second pivot axis, the second pivot pin including a second pin end and a second additional pin end and extending between the second pin end and the second additional pin end along the second pivot axis, and the holder lid being configured to cover at least one of the first pin end and the second pin end at least partially in the attachment state.

12. The battery holder according to claim 11, wherein
the holder body includes a first hole and a second hole,
the first pin end is at least partially provided in the first hole,
the second pin end is at least partially provided in the second hole, and
the holder lid is configured to cover at least one of the first hole and the second hole at least partially in the attachment state.

13. The battery holder according to claim 2, wherein
the side wall includes a recess, and
the cover portion is configured to be at least partially provided in the recess in the attachment state.

14. The battery holder according to claim 13, wherein
the side wall includes a wall portion and a protruding portion,
the protruding portion protrudes from the wall portion away from the holder space, and
the wall portion and the protruding portion define the recess.

15. The battery holder according to claim 14, wherein
the cover portion includes an inclined end surface,
the cover portion extends from the battery receiving portion to the inclined end surface in the first direction,
the inclined end surface is non-perpendicular to and non-parallel to the first direction,
the protruding portion includes an additional inclined end surface,
the additional inclined end surface is non-perpendicular to and non-parallel to the first direction, and
the inclined end surface is configured to face the additional inclined end surface in the attachment state.

16. The battery holder according to claim 2, wherein
the holder space includes an end portion spaced apart from the insertion opening in the first direction, and
the holder space is at least partially provided between the end portion and the battery receiving portion in the first direction in the attachment state.

17. The battery holder according to claim 16, further comprising
a biasing structure coupled to the battery receiving portion to bias the battery toward the end portion in the battery holding state.

18. The battery holder according to claim 17, wherein
the biasing structure is configured to be at least partially provided between the battery and the battery receiving portion in the battery holding state.

19. The battery holder according to claim 1, wherein
the holder lid is at least partially provided farther from a mounting portion than the holder body in a mounting state where the battery holder is mounted to a vehicle body of a human-powered vehicle, and
the base member includes the mounting portion attached to the vehicle body in the mounting state.

20. A bicycle component comprising:
the battery holder according to claim 1.

21. The bicycle component according to claim 20, further comprising:
a base member,
a movable member movable relative to the base member, and
a linkage structure movably coupling the base member and the movable member, the battery holder being provided to the linkage structure.
